(19) United States
(12) Patent Application Publication
(10) Pub. No.: US 2005/0234767 A1
(43) Pub. Date: Oct. 20, 2005

(54) System and method for identifying and monitoring best practices of an enterprise

(76) Inventors: Douglas F. Bolzman, Bay City, MI (US); Sandra A. Christiansen, Lakewood, CO (US); Cynthia T. Reno, Macomb Twp., MI (US)

Correspondence Address: BAKER BOTTS L.L.P., 2001 ROSS AVENUE, 6TH FLOOR, DALLAS, TX, 75201, US

(21) Appl. No.: 10/825,080

(22) Filed: Apr. 15, 2004

(51) Int. Cl. G06F 17/60

(52) U.S. Cl. 705/11

(57) ABSTRACT

In one embodiment, a process for identifying and monitoring one or more best practices of an enterprise includes defining a set of criteria for determining whether each of a plurality of practices of the enterprise qualify as a best practice of the enterprise. The process also includes receiving a practice profile of a particular practice of the enterprise, the practice profile comprising information associated with the particular practice and relating to one or more of the criteria. The process also includes performing a maturity assessment process to determine, based on a comparison between the practice profile for the particular practice and the set of criteria, whether the particular practice qualifies as a best practice of the enterprise and, if the particular practice so qualifies, assigning a best practice maturity level to the particular practice, the best practice maturity level defining to what degree the particular practice qualifies as a best practice of the enterprise.

### TECHNICAL FIELD OF THE INVENTION

This invention relates generally to management of business practices, and more particularly to a system and method for identifying and monitoring best practices of an enterprise.

### BACKGROUND

Business enterprises typically use a number of practices, including for example processes, methodologies, methods, frameworks, or other functions or tools, for carrying out their business with one or more clients. Typically, these clients may be internal to the enterprise or external to the enterprise. For example, an enterprise may use one or more practices for managing change within the enterprise. It may be desirable to identify which of the practices used by the enterprise are the best practices of the enterprise. This identification is often difficult, however, due to lack of communication within the enterprise, the sheer size of the enterprise, disparate business units, or for other reasons.

### SUMMARY OF THE INVENTION

According to the present invention, disadvantages and problems associated with previous techniques for managing business practices may be reduced or eliminated.

In particular embodiments, a process for identifying and monitoring one or more best practices of an enterprise includes defining a set of criteria for determining whether each of a plurality of practices of the enterprise qualify as a best practice of the enterprise. The process also includes receiving a practice profile of a particular practice of the enterprise, the practice profile comprising information associated with the particular practice and relating to one or more of the criteria. The process also includes performing a maturity assessment process to determine, based on a comparison between the practice profile for the particular practice and the set of criteria, whether the particular practice qualifies as a best practice of the enterprise and, if the particular practice so qualifies, assigning a best practice maturity level to the particular practice, the best practice maturity level defining to what degree the particular practice qualifies as a best practice of the enterprise.

In certain embodiments, the present invention provides a uniform approach to management of business practices, which by using a consistent, predefined set of criteria may help reduce or eliminate ambiguity and misunderstandings in management of business practices. In certain embodiments, the present invention is a web-based, custom application. In certain embodiments, the present invention provides an integrated set of business practices to either one or more internal clients of an enterprise or to one or more clients external to the enterprise that may assist in providing service excellence, enabling growth opportunities and possibly leading to increased revenue for the enterprise.

In certain embodiments, the present invention may help ensure that a substantially consistent process is used for identifying and monitoring best practices of an enterprise. For example, the present invention may use a predefined set of criteria organized into categories for identifying and monitoring one or more best practices of the enterprise. In certain embodiments, by using a set of predefined criteria, the present invention may provide substantially predictable results for identifying and monitoring best practices of an enterprise, which may increase efficiency for users of the best practices. In certain embodiments, the present invention provides a substantially consistent mechanism for managing the maturity of each best practice, which may help provide an effective means to plan for future releases of the best practice.

In certain embodiments, the present invention may help reduce or eliminate duplicative practices used by an enterprise by identifying which practices are the best practices of the enterprise and monitoring the maturity of those best practices. For example, the present invention may help identify overlays, gaps, inconsistencies, and compatibilities among practices used by the enterprise.

Certain embodiments of the present invention may provide some, all, or none of the above technical advantages. Certain embodiments may provide one or more other technical advantages, one or more of which may be readily apparent to those skilled in the art from the figures, descriptions, and claims included herein.

### BRIEF DESCRIPTION OF THE DRAWINGS

For a more complete understanding of the present invention and features and advantages thereof, reference is now made to the following description, taken in conjunction with the accompanying drawings, in which:

FIG. 1 illustrates an example system for identifying and managing one or more best practices of an enterprise;

FIG. 2 illustrates an example process for adding a best practice;

FIGS. 3A-3F illustrates an example practice profile template;

FIG. 4 illustrates an example maturity assessment process for determining whether a practice qualifies as a best practice of an enterprise and, if so, what best practice maturity level should be assigned to the practice;

FIGS. 5A-5B illustrate an example maturity assessment spreadsheet template, which may be populated and used for rating the performance of a particular practice;

FIGS. 6A-6B illustrate an example maturity assessment spreadsheet populated with scores for a particular practice; and

FIG. 7 illustrates an example review maturity assessment criteria process.

### DESCRIPTION OF EXAMPLE EMBODIMENTS

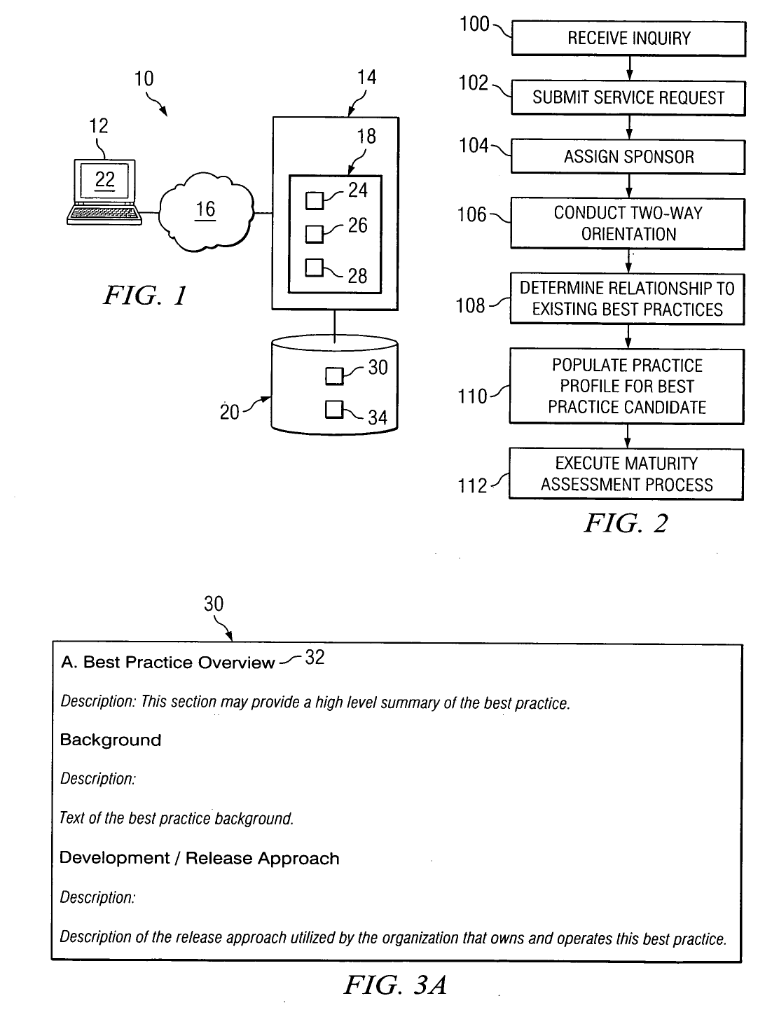

FIG. 1 illustrates an example system 10 for identifying and managing one or more best practices of an enterprise. In particular embodiments, system 10 includes one or more user systems 12 coupled to a server system 14 via a network 16. System 10 may also include a best practices tool 18, on server system 14 for example. Best practices tool 18 may be used to identify and monitor one or more best practices of an enterprise. In particular embodiments, a practice of an enterprise may gain one or more benefits by becoming a best practice of the enterprise. For example, practices recognized as best practices may have a sustainable funding source, receive the sponsorship of the enterprise, have a link from a centralized web site for multiple best practices of the enterprise, be integrated with one or more other best practices of the enterprise, be consistent with the best practice standards of the enterprise, or gain other suitable advantages. Other embodiments of system 10 may be used without departing from the scope of this description.

In general, system 10 may be used to identify and monitor one or more best practices of an enterprise in a substantially consistent manner. In particular embodiments, a user system 12 may submit information associated with a practice to server system 14 for consideration of the practice as a best practice of an enterprise. For example, user system 12 may submit a practice profile including information regarding the practice. Best practices tool 18 on server system 14 may facilitate a determination of whether the practice qualifies as a best practice of the enterprise and, if so, what best practice maturity level should be assigned to the practice. In particular embodiments, this determination is made based on a set of predefined criteria for determining whether each of a plurality of practices of the enterprise qualify as a best practice of the enterprise and, if so, what best practice maturity level should be assigned to the practice, each best practice maturity level defining to what degree a practice qualifies as a best practice.

Practices of an enterprise may include a process, method, framework, methodology, or other suitable function or tool of the enterprise. Practices may be used by an enterprise to provide services or products to one or more clients internal to the enterprise (e.g., a business unit of the enterprise) or to one or more clients external to the enterprise (e.g., a customer of the enterprise such as another enterprise). For example, a practice of an enterprise may include a process for managing change within the enterprise, a process for application development, a process for engineering development and maintenance, or any other suitable practices according to particular needs.

As mentioned above, a best practice of an enterprise may include a process, method, framework, methodology, or any other suitable function or tool of the enterprise. A framework may include a level of a methodology that defines the highest level context for any discipline or specialty. A framework may express one or more generic activities and deliverables that a methodology addresses, which may include high-level work elements and work products supported by the methods and processes within that methodology. A framework may provide a common structure that facilitates sharing and integrating methodology components at the method and process levels among multiple units and teams of the enterprise. Common terms and views, which may be established by the framework, may enhance consistency and coordination among the methods and processes within a methodology and may also facilitate the search and selection of appropriate method and process components to support a specific piece of work. The framework may identify common links between a methodology and other disciplines. In particular embodiments, multiple frameworks may exist, each including the appropriate combinations of new and existing methods and processes that satisfy a given scope.

A method may include a level of a methodology that provides a collection of components that describe individual aspects of the work performed within a relevant discipline. The method may also describe one or more general links or dependencies among these components. In particular embodiments, each methodology may have multiple methods, each individually defining a general approach to performing a portion of, or all of, the work supported by the methodology. To describe the general approach, each method may specify the description, purpose, and relationship of work elements, such as tasks, work products, inputs, and outputs. The method may define one or more detailed links with other disciplines and cross-discipline functions. Additionally, the method may reference techniques, tools, and other performance support for accomplishing a task or producing a work product.

A process may include a level of a methodology that applies the components defined in one or more methods and reuses portions of other processes to best support the actual performance of work. The process may assist in the selection and ordering of work elements as needed to accomplish a specific work type, such as systems development, maintenance, or integration, in a specific environment. Factors influencing the environment may include choices in tools, techniques, and industry. Various work products for supporting the links to other process disciplines and cross-discipline functions may be integrated in sufficient detail to provide repeatability across multiple business units or teams. Tools and techniques associated with the method may be selected in a manner consistent with the technology policies of the enterprise.

For simplicity, throughout the remainder of this description, the term “practice” will be used to refer to a process, method, framework, methodology, or other suitable tool or function of the enterprise. Although the term “enterprise” is used primarily to refer to a business enterprise, the present invention contemplates identifying and monitoring best practices of any suitable organization and the term “enterprise” is intended to encompass all such organizations. Furthermore, throughout the remainder of this description, the term “client” may refer to a client internal to the enterprise or a client external to the enterprise. The term “automatically” as used herein generally means that the appropriate processing is substantially performed by system 10. It should be understood, however, that “automatically” further contemplates any suitable user interaction with system 10.

In particular embodiments, system 10 provides a web-based solution for identifying and monitoring best practices of an enterprise. The design of system 10 may be based, in whole or in part, on one or more templates, which may provide simple navigation via a suitable web browser. System 10 may allow users to work with data in substantially real time, while uploading and downloading information as desired. In particular embodiments, system 10 is managed using built-in security, policing, auditing, and other suitable features.

In particular embodiments, system 10 may enable one or more best practices of an enterprise to be identified and monitored by evaluating practices of the enterprise to determine if the practices qualify as a best practice. In general, best practices of an enterprise may include those practices that meet certain criteria (e.g., the maturity assessment criteria) defined by the enterprise as being desirable or necessary for best practices of the enterprise. The use of the term “best” to describe best practices of the enterprise is not necessarily meant in a literal sense. For example, system 10 may enable practices of the enterprise to be evaluated based on a set of predefined criteria to determine if the practices qualify as a best practice of the enterprise. If a practice qualifies as a best practice, system 10 may enable a best practice maturity level to be assigned to the practice based on the same or a different set of criteria. The best practice maturity levels may define to what degree a practice qualifies as a best-practice of the enterprise. System 10 may enable best practices of an enterprise to be reviewed at regular intervals or at other suitable times to determine if the best practices still meet the predefined criteria for qualifying as a best practice. In particular embodiments, system 10 may enable a best practice to be assigned a new best practice maturity level based on the review of the best practice with respect to the predefined criteria. System 10 may also enable the predefined criteria used to determine whether a practice qualifies as a best practice to be reviewed at regular intervals or at other suitable times to determine if the predefined criteria reflect the current view of the enterprise for determining best practices of the enterprise.

As described above, a practice of an enterprise determined to be a best practice of the enterprise may be assigned a best practice maturity level. For example, a practice being submitted for consideration as a best practice may be assigned a maturity level. As another example, a practice that is an existing best practice of an enterprise may be assigned a maturity level that is the same as or different from its current maturity level, at an annual review for example. In particular embodiments, the best practice maturity levels include the following maturity levels listed in ascending order of maturity: a best practice candidate, an associate best practice, a standard best practice, a mastery best practice, or any other suitable maturity levels according to particular needs. In particular embodiments, the maturity levels include a rejection maturity level indicating that a practice has been rejected as a best practice of the enterprise.

A practice may be assigned best practice candidate status when the practice is submitted for consideration as a new best practice of the enterprise using an add best practice process described in more detail below. For example, a process may be classified as a best practice candidate from the point that a service request and a practice profile is received until the actual maturity assessment process is performed. Associate best practice status may be assigned to a practice that has met and demonstrated minimum criteria for becoming an associate best practice and is in the process of creating a plan to become a standard best practice, the next higher maturity level. In particular embodiments, the threshold criteria for becoming an associate best practice is relatively low. Standard best practice status may be assigned to a practice that has met and demonstrated the minimum criteria to become a standard best practice and is in the process of creating a plan to become a mastery best practice, the next higher maturity level. Mastery best practice status may be assigned to a practice that has met and demonstrated the minimum criteria to become a mastery best practice and is in the process of creating a plan to comply with optional criteria, if applicable. Optional criteria may include additional enhancements to the practice beyond the requirements for qualifying as a mastery best practice. Although these four best practice maturity levels are primarily described, the present invention contemplates any suitable number and types of best practice maturity levels for identifying the maturity of a best practice, according to particular needs.

In particular embodiments, one or more of the following categories of maturity assessment criteria (i.e., the set of predefined criteria) may be used to assign a maturity level to a best practice: value, client, community of practice, training, assets, internal governance, release management, integration, external recognition, external integration, external governance. The content and arrangement of these categories of maturity assessment criteria merely represent a non-limiting example. The categories of maturity assessment criteria listed may not be required and others not listed may be included and still fall within the spirit and scope of the present invention. In particular embodiments, the categories of maturity assessment criteria as well as the maturity assessment criteria within each category are customizable, for example, for particular enterprises, for enterprises within a particular industry, or in any other suitable manner. In particular embodiments, the maturity assessment criteria may be thought of as rules defining what best practices qualify as an associate best practice, what best practices qualify as a standard best practice, and what best practices qualify as a mastery best practice. Example categories of maturity assessment criteria and the maturity assessment criteria within each category are described in more detail below.

In particular embodiments, the categories of maturity assessment criteria may include a value category, which may include one or more maturity assessment criteria for determining the value of the practice to the enterprise. For example, such criteria may be used to determine if value exists for the process and, if so, is the value connected with viable client expectations. Furthermore, the value of the practice may be measured using one or more business value metrics. The value category may include one or more of the following maturity assessment criteria:

(1) Does the practice have a clearly stated objective? In particular embodiments, a practice should meet this criterion to qualify for any of the best practice maturity levels.

(2) How is value defined/measured for the practice? In particular embodiments, to qualify as an associate best practice, the value of the practice should be defined/measured in a written format; however, that value may still need to be validated. In particular embodiments, to qualify as a standard best practice, the value of the practice should be defined/measured in a written format, and that value may already be validated. In particular embodiments, to qualify as a mastery best practice, the value of a practice should exist and be directly connected with one or more viable expectations of a client of the enterprise.

(3) Are best practice usage metrics for the practice captured and reported? For example, the number of account plans created for the practice may be used to measure the scope and reach of the practice. In particular embodiments, to qualify as an associate best practice, this criterion need not be met. In particular embodiments, to qualify as a standard best practice, this criterion should be met. In particular embodiments, to qualify as a mastery best practice, this criterion should be met and used to analyze the value of the practice using the usage metrics.

(4) Are best practice business value metrics captured and reported? Example business value metrics may include whether revenue increased, whether costs decreased, or any other suitable type of business value metrics. In particular embodiments, to qualify as an associate best practice, this criterion should be met. In particular embodiments, to qualify as a standard best practice, this criterion should be met. In particular embodiments, to qualify as a mastery best practice, this criterion should be met and used to analyze the value of the practice using the business value metrics.

In particular embodiments, the categories of maturity assessment criteria may include a client category, which may include one or more maturity assessment criteria for determining the relationship of the practice to current or potential clients of the enterprise. The client category may include one or more of the following maturity assessment criteria:

(1) Is the practice applicable across geographies? For example, the enterprise may have offices in the United States, Canada, Latin America, South America, Asia and the Pacific, and Europe. This maturity assessment criteria may be used to determine the applicability of the practice across these geographies. In particular embodiments, to qualify as an associate best practice, the practice should be applicable to a first geographic area (e.g., the United States). In particular embodiments, to qualify as a standard best practice, the practice should be applicable to a second geographic area, which is larger than, but includes, the first geographic area (e.g., the United States, Canada, and Latin and South America). In particular embodiments, to qualify as a mastery best practice, the practice should be applicable to a third geographic area, which includes, but is larger than, the first and second geographic areas (e.g., the United States, Canada, Latin and South America, Asia and the Pacific, and Europe).

(2) To what lines of business (LOBs) does the practice apply? For example, the enterprise may include a number of predefined LOBs. In particular embodiments, to qualify as an associate best practice, the practice should apply to at least one of the LOBs of the enterprise. In this embodiment, to qualify as a standard best practice, the practice should apply to a number of LOBs greater than the number required to qualify as an associate best practice (e.g., the practice should apply to fifty percent of the LOBs of the enterprise). In particular embodiments, to qualify as a mastery best practice, the practice should apply to a number of LOBs greater than the number required to qualify as a standard best practice (e.g., the practice should apply to substantially all of the LOBs of the enterprise).

(3) Are there existing clients to which the practice applies? In particular embodiments, the existing clients include both internal (e.g., business units or divisions of the enterprise) or external to the enterprise. In particular embodiments, to qualify as an associate best practice, a practice should apply to a first predetermined number of existing clients (e.g., one to three internal clients and one to nine external clients). In particular embodiments, to qualify as a standard best practice, a practice should apply to a second predetermined number of existing clients (e.g., four to ten internal clients and ten to twenty-four external clients). In particular embodiments, to qualify as a mastery best practice, a practice should apply to a third predetermined number of existing clients (e.g., eleven or more internal clients and twenty-five or more external clients). In particular embodiments, the first predetermined number of existing clients is less than the second predetermined number of existing clients, which is less than the third predetermined number of existing clients. While existing clients are described, the present invention contemplates this criterion including prospective or past clients, if appropriate or desired.

(4) Do existing client references exist for the practice? For example, this criterion may include one or more success stories associated with the application of the practice to one or more particular clients. An owner of the practice or other suitable person may be able to document the success story in a template for success stories. In particular embodiments, no existing client references are required for a practice to qualify as an associate best practice. In particular embodiments, one to three existing client references are desirable for a practice to qualify as a standard best practice. In particular embodiments, for a practice to qualify as a mastery best practice, one or more of the following may apply: (a) the practice should be associated with four or more existing client references; (b) at least one success story includes an external client reference; and (c) at least one success story aligns to the expected business value of using the practice (i.e. as specified in the value category, for example).

(5) Does the practice support a portfolio strategy of the enterprise? In particular embodiments, to qualify as an associate best practice, a practice should align to a business model of the enterprise. In particular embodiments, to qualify as a standard best practice, a practice should include a future objective to align to one or more capabilities and/or competencies of the enterprise. In particular embodiments, to qualify as a mastery best practice, the practice should be coordinated with marketing and portfolio management organizations of the enterprise to help project future business opportunities.

In particular embodiments, the categories of maturity assessment criteria may include a community of practice category, which may include one or more maturity assessment criteria for determining the applicability of the practice to one or more communities of practice associated with the enterprise. In particular embodiments, a community of practice includes a group of people who share a common goal, a set of problems, or a passion about a topic, and who develop their knowledge and expertise in this area by interacting on a substantially ongoing basis. An example community of practice may include a user group, a project management community, an application development community, or any other suitable group according to particular needs. An enterprise may include any suitable number of communities of practice, including zero. The community of practice category may include the following maturity assessment criterion:

(1) What are the levels of maturity of the one or more communities of practice associated with the practice? In particular embodiments, for a practice to qualify as an associate best practice, one or more of the following may apply: (a) the practice should be associated with at least one community of practice; and (b) communication with members of the community of practice may be one-way from the owners of the practice, through a distribution list for example. In particular embodiments, for a practice to qualify as a standard best practice, one or more of the following may apply: (a) the practice should be associated with at least one community of practice; (b) the vision of the leaders of the community of practice are articulated to community leaders; (c) the one or more communities of practice associated with the practice may have a scope, one or more goals, and one or more responsibilities to help grow and support the practice; and (d) the members of the community of practice may be representative of the user base. In particular embodiments, for a practice to qualify as a mastery best practice, one or more of the following may apply: (a) active participation in the responsibilities and goals of the community of practice should exist; (b) the community of practice may be acknowledged as being a stakeholder in developing practices of the enterprise around the practice; and (c) metrics may be in place to measure progress to goals and responsibilities of the community of practice that support the practice.

In particular embodiments, the categories of maturity assessment criteria may include a training category, which may include one or more maturity assessment criteria for determining whether training exists for the practice. For example, the maturity assessment criteria for the training category may be used to determine the extent and strength of the training available to the enterprise about the practice, including in certain embodiments the number of people available to administer the training. The training category may include one or more of the following maturity assessment criteria:

(1) What training courseware and materials are available for the practice? In particular embodiments, for a practice to qualify as an associate best practice, training courseware and materials should be available to the enterprise. In particular embodiments, for a practice to qualify as a standard best practice, training curriculum should exist. In particular embodiments, for a practice to qualify as a mastery best practice, a certification program should be in place, if appropriate.

(2) Does training capacity exist for the practice? In particular embodiments, for a practice to qualify as an associate best practice, the training capacity may be ad-hoc. In particular embodiments, for a practice to qualify as a standard best practice, self-paced training or classroom-based training should be available. In particular embodiments, for a practice to qualify as a mastery best practice, one or more of the following may apply: (a) enterprise-sponsored training through self-based training or classroom-based training should exist; and (b) training may optionally be available to audiences external to the enterprise.

(3) Are sufficient numbers of mentors available for administering training regarding the practice? In particular embodiments, there is no requirement for mentors for a practice to qualify as an associate best practice. In particular embodiments, for a practice to qualify as a standard best practice, a mentoring program should be implemented. In particular embodiments, for a practice to qualify as a mastery best practice, sufficient mentoring should exist to meet the needs of the enterprise.

In particular embodiments, the categories of maturity assessment criteria may include an assets category, which may include one or more maturity assessment criteria for determining the quantity and quality of assets available for carrying out the practice. Assets may include physical assets such as files, templates, and presentations, as well as human and intellectual assets. The assets category may include one or more of the following maturity assessment criteria:

(1) What is the design of the practice, and does formal documentation for the practice exist? In particular embodiments, for a practice to qualify as an associate best practice, the design of the practice should be defined and formal documentation of the practice should exist. In particular embodiments, for a practice to qualify as a standard best practice, one or more of the following may apply: (a) the design of the practice should be defined; (b) formal documentation of the practice should exist; and (c) a plan for the future of the practice should exist.

(2) What is the accessibility of information associated with the practice? For example, what methods are used to communicate materials to the community of users of the practice? In particular embodiments, for a practice to qualify as an associate best practice, the practice should be associated with an accessible repository of information. In particular embodiments, for a practice to qualify as a standard best practice, a repository of information associated with the practice should be accessible over an electronic network (e.g., an intranet or the Internet). In particular embodiments, for a practice to qualify as a mastery best practice, a repository of information associated with the practice should be accessible over an electronic network (e.g., an intranet or the Internet).

(3) What sales tools are available for the practice? For example, what methods are used to communicate to a prospective client? These sales tools may include marketing material, for example. In particular embodiments, the sales tools include both internal and external marketing material for diverse audiences. A template may be provided for this information. In particular embodiments, for a practice to qualify as an associate best practice, the practice should be associated with an awareness presentation, which could be used to inform clients about the practice. In particular embodiments, for a practice to qualify as a standard best practice, a repository of information associated with the practice should be accessible over an electronic network (e.g., an intranet or the Internet). In particular embodiments, for a practice to qualify as a mastery best practice, a repository of information associated with the practice should be accessible over an electronic network (e.g., an intranet or the Internet).

(4) What implementation support materials exist for the practice? In particular embodiments, no implementation support materials are required for a practice to qualify as an associate best practice. In particular embodiments, for a practice to qualify as a standard best practice, one or more key inputs for creating transition strategies should be in place. For example, these key inputs may include one or more of: (a) key behaviors that will be in place when the practice is in use; (b) benefit statements from different perspectives, including a client perspective, a supplier perspective, a leadership perspective, a practice user perspective, or any other suitable perspectives; and (c) one or more viable approaches for implementing the practice and the pros and cons of each approach. In particular embodiments, for a practice to qualify as a mastery best practice, one or more structures should be in place for supporting the use of the practice. For example, these structures may include a help desk. These structures may be available to answer questions regarding the practice and to review and provide feedback regarding implementation plans for the practice.

(5) What intellectual capital exists for the practice? For example, have outputs of execution of the practice been captured and communicated throughout the community, reused, and leveraged? In particular embodiments, for a practice to qualify as an associate best practice, outputs of execution of the practice should be stored, for the purpose of reuse for example. In particular embodiments, for a practice to qualify as a standard best practice, one or more of the following should apply: (a) outputs of execution of the practice should be stored, for the purpose of reuse for example; and (b) a process should be implemented for the practice that support the knowledge cycle (e.g., information, knowledge, and expertise). In particular embodiments, for a practice to qualify as a mastery best practice, one or more of the following should apply: (a) a repository of outputs of execution of the practice should be a trusted source of reusable assets for the enterprise; and (b) a process should be implemented for the practice that support the knowledge cycle (e.g., information, knowledge, and expertise).

(6) Does global consistency for the practice exist? For example, is common terminology used for the practice throughout one or more relevant geographical areas? In particular embodiments, for a practice to qualify as an associate best practice, a glossary for the practice terminology should be in place. In particular embodiments, for a practice to qualify as a standard best practice, a glossary for the practice terminology should be in place, which is aligned to the use of a best practices glossary. In particular embodiments, for a practice to qualify as a mastery best practice, a glossary for the practice terminology should be in place, which is aligned to the use of a best practices glossary. Furthermore, the terminology of the practice may be used to influence the best practices glossary to align with industry terms.

(7) Is the intellectual property associated with the practice protected? This criteria may also include a consideration of the confidentiality level of the practice, either up to the point of the best practice maturity assessment and/or in the future. For example, is the practice highly confidential to the enterprise, confidential to the enterprise, approved for limited distribution external to the enterprise, or public information? Certain types intellectual property protection may not require that the confidentiality of the practice be maintained. For example, patent protection may be sought for the practice, which may result in disclosure of the patented concepts associated with the practice first to the relevant patent office and eventually to the public. In particular embodiments, there is no requirement that the intellectual property associated with a practice is protected for the practice to qualify as an associate best practice. In particular embodiments, for a practice to qualify as a standard best practice, appropriate intellectual property protection for the practice should be identified. In particular embodiments, for a practice to qualify as a mastery best practice, appropriate intellectual property protection for the practice should be established.

In particular embodiments, the categories of maturity assessment criteria may include an internal governance category, which may include one or more maturity assessment criteria for determining how the practice is governed or otherwise managed. For example, can one person change the practice at any time or do formal procedures and structures exist for managing changes and revisions to the practice? The internal governance category may include one or more of the following maturity assessment criteria:

(1) Does the practice have an owner and funding? An owner of a practice may include an individual, a group of individuals (e.g., a team), or any other suitable entity according to particular needs. In particular embodiments, to qualify as an associate best practice, the practice should be associated with an owner. In particular embodiments, to qualify as a standard best practice, the practice should be associated with an owner and funding should be established for the practice. In particular embodiments, for the practice to qualify as a mastery best practice, one or more of the following may apply: (a) the practice should be associated with an owner; (b) ftunding should be established for the practice; and (c) the internal governance structure should address the service line owner when appropriate.

(2) Is a change control board in place for the practice? In particular embodiments, no change control board for the practice is necessary for the practice to qualify as an associate best practice. In particular embodiments, for the practice to qualify as a standard best practice, one or more of the following may apply: (a) an operational change control board is in place for the practice; and (b) processes and procedures are in place for managing changes and releases of the practice. In particular embodiments, for the practice to qualify as a mastery best practice, one or more of the following may apply: (a) an operational change control board is in place for the practice; and (b) processes and procedures are in place for managing changes and releases of the practice.

(3) Do executive leaders for the targeted implementation base of the practice encourage use of the practice? In particular embodiments, for the practice to qualify as an associate best practice, executive leaders should be named. In particular embodiments, for a practice to qualify as a standard best practice, executive leaders should be named and actively encouraging use of the practice. In particular embodiments, for the practice to qualify as a mastery best practice, use of the practice should be integrated into performance objectives of the enterprise.

(4) Does service offering alignment exist for the practice? In particular embodiments, service offering alignment is not required for the practice to qualify as an associate best practice. In particular embodiments, to qualify as a standard best practice, the practice should the capabilities and service offerings supported by the practice should be identified. In particular embodiments, for the practice to qualify as a mastery best practice, one or more of the following may apply: (a) service line leadership has input to the governance structure of the practice; (b) the practice is formally documented as part of the delivery capability of the service offering; and (c) the practice is evolving to support different engagement approaches for multiple lines of business.

In particular embodiments, the categories of maturity assessment criteria may include a release management category, which may include one or more maturity assessment criteria for determining how future releases of the practice are to be managed. For example, how is the future of the practice forecasted and how is the future direction of the practice established? As another example, is a release plan for the practice established and updated on a regular basis? The release management category may include the following maturity assessment criteria:

(1) What is the direction of the practice? In particular embodiments, for a practice to qualify as an associate best practice, an overall direction for the practice should be established. In particular embodiments, for a practice to qualify as a standard best practice, a formal release plan for the practice should be established and regularly updated. In particular embodiments, to qualify as a mastery best practice, a formal release schedule for the practice should be integrated into one or more planning functions impacted by the release plans of the practice.

In particular embodiments, the categories of maturity assessment criteria may include an integration category, which may include one or more maturity assessment criteria for determining whether and to what degree the practice is implemented with other practices of the enterprise. For example, is progress being made toward integrating the practice with existing best practice practices and a plan to address integration of future best practice practices? The integration category may include the following maturity assessment criteria:

(1) Is the practice aligned with other practices of the enterprise? A low level of integration may be defined as knowing where to leverage the practice within one or more other practices. A medium level of integration may be defined as the plans for the practice are integrated with the plans of one or more other practices. A high level of integration may be defined as the practice is substantially fully integrated with one or more other practices of the enterprise. In particular embodiments, for the practice to qualify as an associate best practice, a list of potential integration points for integrating the practice with one or more other practices should be identified. In particular embodiments, for the practice to qualify as a standard best practice, links or references for integrating the practice with one or more other practices should be identified, if appropriate. In particular embodiments, for the practice to qualify as a mastery best practice, the release plans of the practice should be integrated with the release plans of one or more other practices and the releases of the integrated practices should include integrated activities.

In particular embodiments, the categories of maturity assessment criteria may include an external recognition category, which may include one or more maturity assessment criteria for determining the level of recognition for the practice external to the enterprise (e.g., in a relevant industry). In particular embodiments, the external recognition category applies to practices for producing products or providing services to one or more clients external to the enterprise. The external recognition category may include one or more of the following maturity assessment criteria:

(1) Is the practice benchmarked to external sources? In particular embodiments, it is not required that the practice be benchmarked to external sources for the practice to qualify as an associate best practice. In particular embodiments, for the practice to qualify as a standard best practice, the benchmarking the practice to one or more external sources should be under consideration or exploration. In particular embodiments, for the practice to qualify as a mastery best practice, the practice should have recognition from one or more sources external to the enterprise.

(2) Has the practice been the subject of one or more presentations to sources external to the enterprise? For example, if the practice has been the subject of a presentation at a conference external to the enterprise, there may be at least some external recognition of the practice. In particular embodiments, it is not required that the practice was the subject of one or more presentations to sources external to the enterprise to qualify as an associate best practice. In particular embodiments, for the practice to qualify as a standard best practice, the presentation of the practice to one or more sources external to the enterprise should be under consideration or exploration. In particular embodiments, to qualify as a mastery best practice, the practice should be scheduled to be presented to one or more sources external to the enterprise or already have been to the subject of one or more presentations external to the enterprise.

(3) Has the practice been the subject of one or more white papers? For example, if the practice has been the subject of a white paper, there may be at least some external recognition of the practice. In particular embodiments, it is not required that the practice was the subject of one or more white papers to qualify as an associate best practice. In particular embodiments, for the practice to qualify as a standard best practice, preparation of one or more white papers regarding the practice should be under consideration or exploration, or one or more white papers may exist internally to the enterprise for which external publication is being pursued. In particular embodiments, to qualify as a mastery best practice, one or more white papers for the practice should be published externally to the enterprise.

In particular embodiments, the categories of maturity assessment criteria may include an external integration category, which may include one or more maturity assessment criteria for determining whether and to what degree the practice integrates with one or more other practices external to the enterprise. In particular embodiments, the external integration category applies to practices for producing products or providing services to one or more clients external to the enterprise. The external integration category may include the following maturity assessment criteria:

(1) Is the practice aligned with one or more practices external to the enterprise? In particular embodiments, it is not required that the practice be aligned with one or more practices external to the enterprise to qualify as an associate best practice. In particular embodiments, for the practice to qualify as a standard best practice, integration of the practice with one ore more relevant practices external to the enterprise should be under consideration or exploration. In particular embodiments, to qualify as a mastery best practice, the practice should be integrated with one or more practices external to the enterprise, if appropriate.

In particular embodiments, the categories of maturity assessment criteria may include an external governance category, which may include one or more maturity assessment criteria for determining whether and to what degree the practice enables organizations to meet standards set by external governing bodies (e.g., the International Organization for Standardization), if appropriate. For example, have the white papers and assets describing the practice been taken to a governance board external to the enterprise for consideration as an industry practice. In particular embodiments, the external governance category applies to practices for producing products or providing services to one or more clients external to the enterprise. The external governance category may include the following maturity assessment criteria:

(1) Does the practice enable organizations to meet standards set by one or more external governing bodies, if appropriate? In particular embodiments, for a practice to qualify as an associate best practice, whether to formulate the practice to enable organizations to meet standards set by one or more external governing bodies should be under consideration or exploration. In particular embodiments, for a practice to qualify as a standard best practice, the practice should enable organizations to meet standards set by one or more external governing bodies if the market dictates that this should be the case. In particular embodiments, for a practice to qualify as a mastery best practice, the practice should enable organizations to meet standards set by one or more external governing bodies if the market dictates that this should be the case and if it is to the business advantage of the enterprise.

Returning to the example embodiment of system 10 illustrated in FIG. 1 and as discussed above, user systems 12 may submit practices (e.g., using practice profiles) to server system 14 to determine if the practices qualify as best practices of the enterprise and if so, what best practice maturity level should be assigned to the practices. User systems 12 may be referred to generally in the singular as user 12 or in the plural as users 12. Moreover, “user system 12” and “user of user system 12” may be used interchangeably. User systems 12 may be associated with an enterprise. In particular embodiments, user systems 12 and server system 14 are associated with the same enterprise; however, the present invention contemplates the enterprise with which user systems 12 are associated being different from the enterprise with which server system 14 is associated. Users of user system 12 may include various employees of the enterprise, employees of a third party providing services to the enterprise, or any other suitable users according to particular needs. User system 12 may include any appropriate input devices, output devices, mass storage media, processors, memory, or other suitable components for receiving, processing, storing, and communicating information. Each user system 12 may operate using a different user platform, or two or more user systems 12 may operate using identical user platforms.

Although one user system 12 is illustrated, the present invention contemplates system 10 including any suitable number of user systems 12 according to particular needs. For example, in particular embodiments, server system 14 is coupled to multiple distributed user systems 12. User systems 12 may be physically distributed, being in different physical locations geographically remote from each other and from server system 14, or logically distributed, being at approximately the same location as other user systems 12 and server system 14. Each user system 12 may be coupled to server system 14 via network 16. Network 16 may include one or more computer buses, local area networks (LANs), metropolitan area networks (MANs), wide area networks (WANs), a global computer network such as the Internet, or any other wireline, optical, wireless, or other links.

Server system 14 includes one or more electronic computing devices operable to receive, transmit, process, and store data associated with system 10. More specifically, server system 14 is operable to receive from user systems 12 information regarding practices (e.g., in the form of practice profiles). Server system 14 is also operable to determine, using best practices tool 18 for example, whether the practices associated with the information qualify as best practices of the enterprise and if so, what best practice maturity level should be assigned to the practices. Server system 14 may include a web server. One function of the web server (or a pool of servers) might be to allow user systems 12 to send or receive content over or from the Internet using a standard user interface language such as, for example, Hypertext Markup Language (HTML). In particular embodiments, server system 14 may accept input from user system 12 via a web browser and return appropriate HTML pages.

Server system 14 may include or may be otherwise coupled to a database 20, which may include any memory or database module and may take the form of volatile or non-volatile memory including, without limitation, magnetic media, optical media, random access memory (RAM), read-only memory (ROM), removable media, or any other suitable local or memory component. In particular embodiments, database 20 includes one or more SQL servers. User systems 12, server system 14, and database 20 may each include an appropriate combination of hardware and software associated with one or more computer systems at one or more locations. These components of system 10 may share data storage, communications, or other resources according to particular needs. Each computer system may include one or more suitable input devices, output devices, mass storage media, processors, memory, or other components for receiving, processing, storing, and communicating information according to the operation of system 10.

Server system 14 supports best practices tool 18, which may be used for identifying and monitoring one or more best practices of an enterprise. For example, best practices tool 18 may be used to store information regarding the practices of an enterprise and to manage the best practices of the enterprise using the stored information regarding the practices, along with any other suitable information. In particular embodiments, best practices tool 18 is a web-enabled software application, although the present invention contemplates best practices tool 18 being implemented in any suitable manner. For example, best practices tool 18 may be associated with or implemented using a web site, which provides a central point of access for user systems 12. Best practices tool 18 may be implemented using any suitable combination of software, firmware, and hardware. In a particular embodiment, best practices tool 18 may be written in Active Server Pages (ASP) and MICROSOFT Virtual Basic Scripts (VBScripts), and may use MICROSOFT SQL 2000 as a database 20. User systems 12 may interact with best practices tool 18 using a graphical user interface (GUI) 22 such as may be associated with a web browser. Users of user system 12 may input and modify information regarding practices into GUI 22, and server system 14 may store and manipulate the information regarding the practices in database 20. Any other type of interface could be used without departing from the scope of the invention.

As described briefly above, best practices tool 18 may be used to identify and monitor one or more best practices of an enterprise. In particular embodiments, a practice may gain one or more benefits by becoming a best practice of the enterprise. For example, practices recognized as best practices may have a sustainable funding source, receive the sponsorship of the enterprise, have a link from a centralized web site for multiple best practices of the enterprise, be integrated with one or more other best practices of the enterprise, be consistent with the best practice standards of the enterprise, or gain other suitable advantages.

In particular embodiments, best practices tool 18 includes an add best practice module 24, a maturity assessment module 26, and a review maturity assessment criteria module 28. Add best practice module 24 may be operable to perform an add best practice process and may be used by a user of user system 12 to submit a request for a practice to be considered for addition as a new best practice. For example, a user of user system 12 may use add best practice module 24 to populate a practice profile template with information regarding a particular practice to be considered as a new best practice. Maturity assessment module 26 may be operable to perform a maturity assessment process for determining whether a particular practice qualifies as a best practice of the enterprise and if so, determine what best practice maturity level should be assigned to the particular practice. For example, maturity assessment module may facilitate population of a maturity assessment spreadsheet template with information specific to an assessment of a particular practice. In particular embodiments, the particular practice may include a practice submitted for consideration as a new best practice (e.g., a best practice candidate). In other embodiments, the particular practice includes an existing best practice of the enterprise undergoing a review to determine if the practice still qualifies as a best practice and if so, whether the maturity level assigned to the best practice should be changed. Review maturity assessment criteria module 28 may be operable to perform a review maturity assessment criteria process for reviewing the maturity assessment criteria to determine if the criteria reflect current views of the enterprise for determining best practices of the enterprise and refining the criteria if necessary or desired. Each of these example modules is described in more detail below.

While add best practice module 24, maturity assessment module 26, and review maturity assessment criteria module 28 are primarily described, the present invention contemplates best practices tool 18 including any suitable modules according to particular needs. Furthermore, the functionality described with reference to each of the modules may be shared or divided among these modules or other modules in any suitable manner according to particular needs.

Add best practice module 24 may be used by a user of user system 12 to submit a request for a practice to be considered for addition as a new best practice. For example, the user may include an individual or group of individuals associated with the practice, who desire for the practice to be assessed for qualification as a best practice. In particular embodiments, the user selects an add best practice link of best practices tool 18, at a web site associated with best practices tool 18 for example, which may invoke add best practice module 24. In particular embodiments, the practice being submitted for consideration as a best practice may be assigned a unique identification number. Add best practice module 24 may be operable to perform an add best practice process.

FIG. 2 illustrates an example process for adding a best practice. In particular embodiments, the process described with reference to FIG. 2 may be referred to as an “add best practice process.” At step 100, add best practice module 24 or another suitable component of system 10 may receive an inquiry for adding a practice as a new best practice of the enterprise. For example, a user of user system 12 may submit a service request for a practice to be assessed for consideration as a best practice of the enterprise. At this point, the practice being submitted for consideration as a best practice may be referred to as a “best practice candidate.”

At step 102, a service request may be submitted for the best practice candidate, by a user of user system 12 for example. In particular embodiments, the inputs to step 102 include a populated practice profile for the best practice candidate, as described below. An owner of the best practice candidate (e.g., a user of user system 12) may submit the service request and the populated practice profile for the best practice candidate. The output of step 102 may include the submitted service request. In particular embodiments, the individual responsible for step 102 includes the owner of the best practice candidate.

At step 104, the best practice candidate may be assigned one or more sponsors. For example, add best practice module 24 or another suitable component of system 10 may automatically or in combination with one or more suitable individuals assign one or more sponsors to the best practice candidate. In particular embodiments, the inputs to step 104 include the submitted service request and the populated practice profile for the best practice candidate. A master scheduler may be responsible for assigning a sponsor to the best practice candidate to assist in completing the steps for having a best practice maturity level assigned to the best practice candidate, if appropriate.

At step 106, a two-way orientation for the best practice candidate may be conducted. For example, add best practices module 24 or another suitable component of system 10 may automatically or in combination with one or more suitable individuals facilitate the two-way orientation. In particular embodiments, the inputs to step 106 include a best practice integration program overview, a best practice integration web overview, a best practice candidate overview, or any other suitable inputs according to particular needs. In particular embodiments, a session is held to conduct orientations regarding the best practice integration program and the best practice candidate. The next steps in the process may also be discussed at the session. If the best practice candidate overlaps or shares the same space as an existing best practice, justification may be provided to explain why the best practice candidate should be a separate best practice of the enterprise. In particular embodiments, the outputs of step 106 include an oriented owner of the best practice candidate, an oriented sponsor of the best practice candidate, and an oriented integration lead for the best practice candidate. In particular embodiments, the individuals responsible for step 106 include the owner of the best practice candidate, the sponsor of the best practice candidate, and the integration lead for the best practice candidate.

At step 108, the relationship between the best practice candidate and other existing best practices may be determined. For example, add best practices module 24 or another suitable component of system 10 may automatically or in combination with one or more suitable individuals facilitate the determination of the relationship between the best practice candidate and other existing best practices of the enterprise. In particular embodiments, the inputs to step 108 include a functional view of the best practice candidate, an integrated client relationship life cycle for the best practice candidate, an enterprise-level business model view of the best practice candidate, a situation view of the best practice candidate, and an overview of the best practice candidate. In particular embodiments, the client relationship life cycle, the purpose, and the major inputs and outputs of the best practice candidate may be used to determine if the best practice candidate overlaps or shares the same space as an existing best practice.

If the best practice candidate shares the same space as an existing best practice, the candidate best practice may be requested to submit a change request to improve the existing best practice rather than introduce a new best practice. If the best practice candidate overlaps with an existing best practice and there is not a relatively strong business case for there to be two separate best practices, the best practice candidate may be requested to submit a change request to improve and/or extend the existing best practice. In particular embodiments, the outputs of step 108 include an update to the service request including the results of determining the relationship of the best practice candidate to existing best practices. In particular embodiments, the individuals responsible for step 108 include the owner of, the sponsor of, and the integration lead for the best practice candidate.

At step 110, a practice profile template may be populated with information specific to the best practice candidate. For example, the practice profile template for a best practice candidate may be populated with data regarding the best practice candidate. In particular embodiments, a user of system 10 such as the owner assigned to the best practice candidate may access server system 14 to complete the template. In particular embodiments, the inputs to step 110 include a candidate best practice profile template. In particular embodiments, the owner of the best practice candidate populates the candidate best practice profile template with relevant information regarding the best practice candidate. In particular embodiments, the outputs of step 110 include the populated candidate best practice profile for the best practice candidate. In particular embodiments, the individuals responsible for step 110 include the owner of the best practice candidate.

In particular embodiments, a practice profile template 30 (illustrated in FIG. 1, for example) is stored in database 20. In response to a user request to add a new best practice, add best practice module 24 may automatically or in combination with one or more suitable individuals or components of system 10 access database 20, retrieve practice profile template 30, and communicate or otherwise present practice profile template 30 to user system 12. The user of user system 12 may populate practice profile template 30 with data relating to the practice that the user desires to be considered for qualification as a best practice.

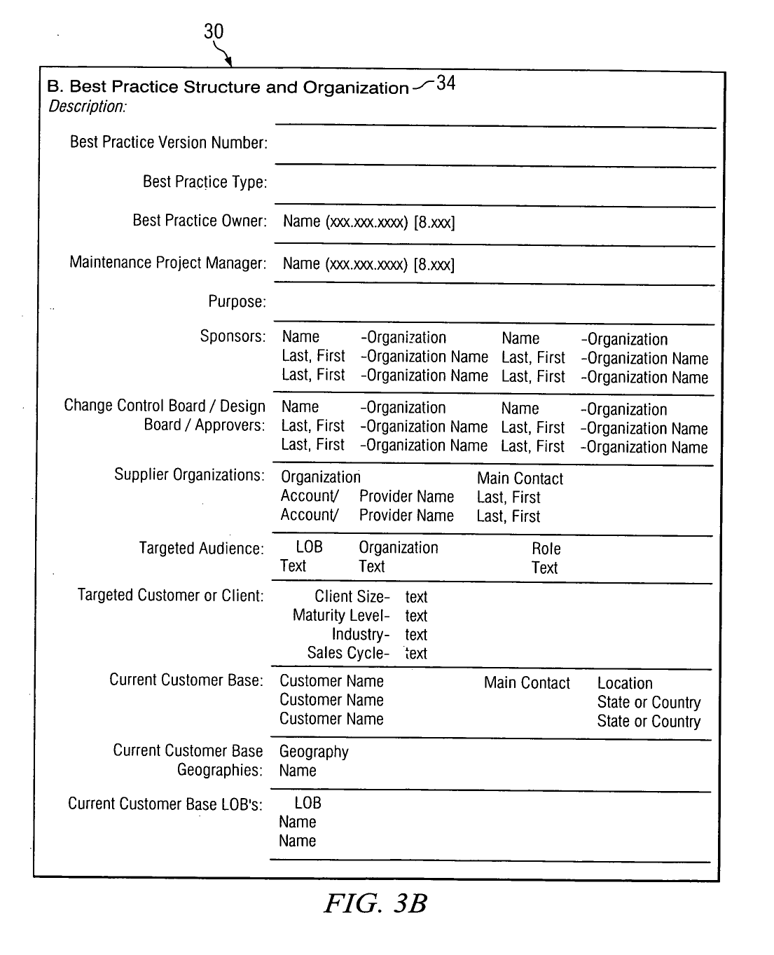

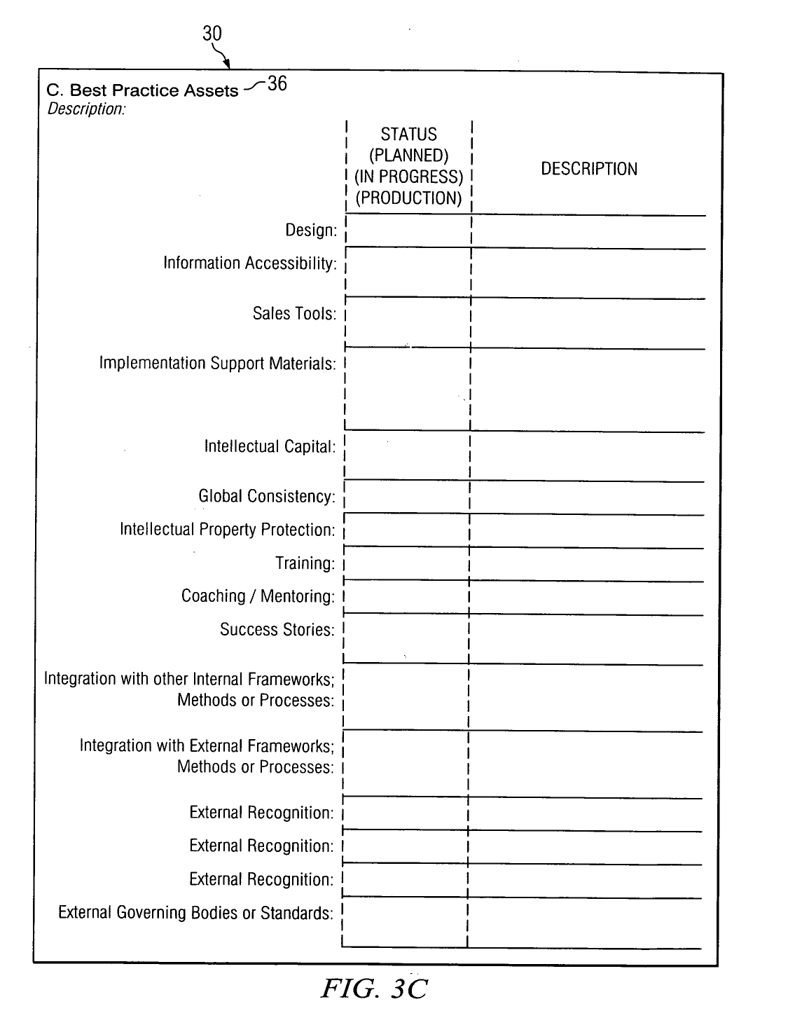

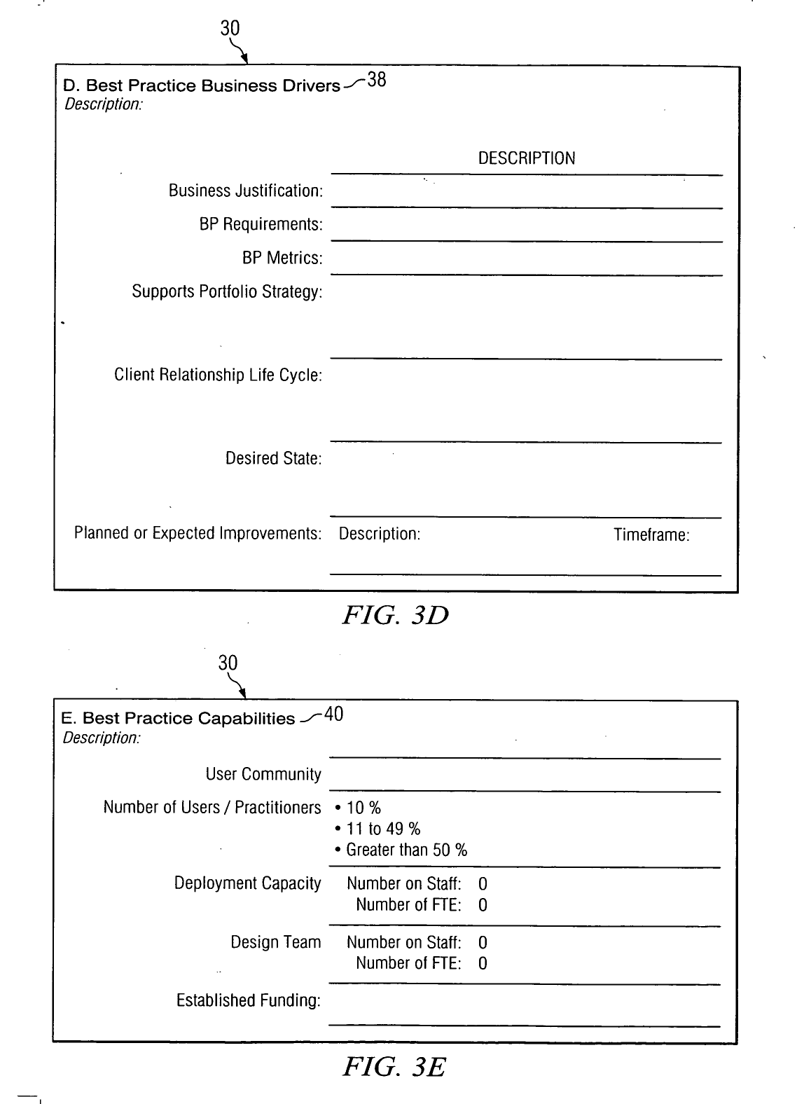

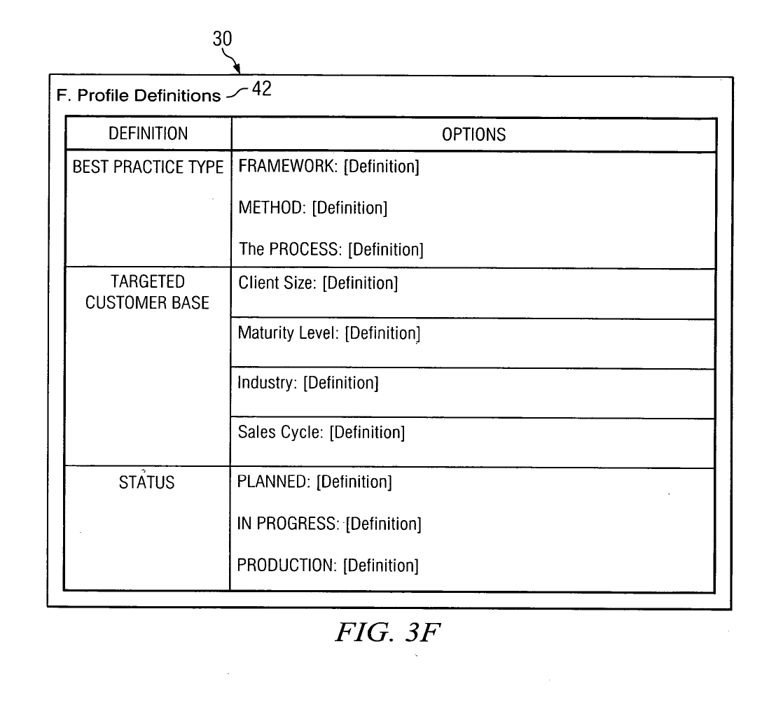

FIGS. 3A-3F illustrates an example practice profile template 30. In particular embodiments, practice profile template 30 includes fields for sufficient information to determine whether and to what degree a practice for which practice profile template 30 is completed meets the maturity assessment criteria. Practice profile template 30 may be in any suitable format, including without limitation a MICROSOFT WORD document, an ASP, any suitable type of web document, or any other suitable format. In particular embodiments, once a practice profile template 30 is completed for a particular practice, the practice profile is stored in database 20 or another suitable location and may be updated by a user of user system 12 or other suitable person.

In particular embodiments, before a best practice candidate is submitted for consideration as a best practice or before an existing best practice undergoes a review, a practice profile template 30 may be completed for the practice or a practice profile may be updated for the practice, respectively. For example, practice profile template 30 may be used, which may be populated by one or suitable individuals with relevant information regarding the best practice candidate or the existing best practice. In particular embodiments, the owner of the best practice candidate or the existing best practice is responsible for populating practice profile template 30. In particular embodiments, practice profile template 30 is stored on database 20 and may be accessed by the appropriate individuals. Although practice profile template 30 may include fields for any suitable information according to particular needs, in particular embodiments, practice profile template 30 includes fields for information relevant to the various maturity assessment criteria and categories.

As just one example, practice profile template 30 includes one or more of the following sections: a best practice overview section 32; a best practice structure and organization section 34; a best practice assets section 36; a best practice business drivers section 38; a best practice capabilities section 40; a profile definitions section 42; and any other suitable sections according to particular needs. Each of these example sections of practice profile template 30 is described below. Although each section is described with reference to a best practice candidate, practice profile template 30 and its sections may be used for an existing best practice (e.g., having been previously populated when the best practice was a best practice candidate and subsequently updated) in a substantially similar manner.

As illustrated in FIG. 3A, best practice overview section 32 may include background information regarding the best practice candidate. For example, background information may include who started the best practice candidate, what was the driving force behind the best practice candidate, when was the best practice candidate first released, who was involved in the development of the best practice candidate, approximately how many updates have been made to the best practice candidate since its initial development, a brief history of the use of the best practice candidate, or any other suitable information. The background section may also include information regarding the development and release approach of the best practice candidate, including, for example, the overall plan for defining, designing, deploying, and operating the best practice candidate.

As illustrated in FIG. 3B, best practice structure and organization section 34 may include information regarding the high-level structure of the best practice candidate. For example, best practice structure and organization section 34 may include one or more of the following:

(a) A best practice version number for the best practice candidate. In particular embodiments, the version number of a best practice candidate is assigned when the add best practice process is initiated (e.g., by invoking add a best practice module 22) for the best practice candidate.

(b) A best practice type for the best practice candidate (e.g., process, method, framework, methodology, or other suitable type).

(c) An identification of an owner of the best practice candidate. The owner of the best practice candidate may provide a single point of accountability for the best practice candidate.

(d) An identification of a maintenance project manager responsible for development and maintenance of the best practice candidate.

(e) A statement of the purpose of the best practice candidate (e.g., the business function of the best practice candidate).

(f) Information regarding one or more sponsors of the best practice candidate. A sponsor may include a manager or other suitable individual within the enterprise who is committed to the success or accountable for the failure of the best practice candidate.

(g) Information regarding the change control board, design board, and approvers for the best practice candidate. For example, these individuals may include the people who have the responsibility to approve all of the deliverables of the best practice candidate prior to its release.

(h) Information regarding the target audience of the best practice candidate. The target audience may include those who would use the best practice candidate.

(i) Information regarding one or more targeted customers or clients who would receive the output from the best practice candidate. For example, information regarding a targeted customer or client may include the client size, which may define for what size client or customer the best practice candidates is scoped to target. As another example, information regarding a targeted customer or client may include client maturity level information, which may define what level of customer or client maturity a target customer or client should have. Customer or client maturity level may include the sophistication of the client's information technology. As another example, information regarding a targeted customer or client may include information regarding the one or more industries of typical customers or clients that are targets of the best practice candidate. As another example, information regarding a targeted customer or client may include information regarding the sales cycle of the enterprise at which the best practice candidate would be used. For example, the best practice candidate may be used at a discover phase, a define phase, a confirm phase, a deliver phase, or at any other suitable sales cycle phase according to particular needs.

(j) Information regarding the current customer base for the best practice candidate. The current customer base may include individuals or organizations that have purchased or utilized products or services associated with the best practice candidate (e.g., the entity that receives the benefit of the best practice candidate).

(k) Information regarding the geographies of the current customer base (e.g., the United States, Canada, Latin and South America, Asia and the Pacific, Europe, the Middle East, Africa, etc.).

(l) Information regarding the LOBs of the current customer base (e.g., solutions consulting, operations solutions, etc.).

As illustrated in FIG. 3C, best practice assets section 36 may define the collateral associated with the best practice candidate. In particular embodiments, an asset includes a physical item of computer or other equipment, documents, personnel, files, or other suitable assets, which may be used or otherwise associated with the best practice candidate. For purposes of this description, the term “asset” is a generic term given to any valuable item. A best practice candidate may be use or otherwise be associated with any suitable number of assets.

For each of the types of information included in best practice assets section 36, the template may include an entry requesting the status of the assets associated with the information. Certain predefined status entries may be requested, including planned, in-progress, and in-production. A status of planned may indicate that a need for this type of asset has been identified and that there is a plan or intent to develop it in a future release of the best practice candidate. A status of in-progress may indicate that the asset is currently being designed, but that it has not yet been released into the field, certified for use, or used in a client environment. A status of in-production may indicate that the asset is designed, tested, and integrated into the overall best practice collateral, it is used in a client environment, and it has been certified to function as was intended. In particular embodiments, best practice assets section 36 may include fields for entry of information relating to one or more of the following:

(a) Design assets providing formal documentation of the process and application associated with the best practice candidate.

(b) Information accessibility assets providing the location and methods used to communicate materials to the user community of the best practice candidate (e.g., Global Web Hosting).

(c) Sales tools providing a list of all sales presentations, brochures, and materials available to communicate the best practice candidate features, functions, and benefits.

(d) Implementation support materials, including the materials available for implementing the best practice candidate in a client environment (e.g., implementation guidelines, tailoring guidelines, communication packages, getting started packages, frequently asked questions materials, etc.).

(e) Intellectual capital, including that the outputs of execution of the best practice candidate have been captured and communicated throughout the user community, have been reused, and have been leveraged.

(f) Global consistency, including that a common terminology has been established for the best practice candidate.

(g) Intellectual property protection, including whether appropriate intellectual property protection has been identified or established for the best practice candidate.

(h) Training, including whether a training curriculum exists and if so, whether it is sponsored by the enterprise.

(i) Coaching/mentoring, including whether a mentoring program is available and if so, whether there are sufficient mentors available.

(j) Success stories, including whether there are past implementations of the best practice candidate that can be used to communicate the value of the best practice candidate.

(k) Integration with other processes internal to the enterprise, including a list of enterprise processes that have been aligned with the design of the best practice candidate.

(l) Integration with other processes external to the enterprise, including a list of industry processes that have been aligned with the design of the best practice candidate.

(m) External recognition, including whether the best practice candidate has been benchmarked to one or more sources external to the enterprise, presented at one or more conferences external to the enterprise, or published in a white paper or other document available externally to the enterprise.

(n) External governing bodies or standards, including, if appropriate, whether the best practice candidate is created to enable an organization to meet standards of governing bodies.

As illustrated in FIG. 3D, best practice business drivers section 38 may define one or more business drivers that have been used to develop the best practice candidate. The sources of this information may include customers, service providers, business initiatives, corporate directives, or any other suitable source. For each of the types of information included in best practice business drivers section 38, the template may include an entry requesting the status of the business drivers associated with the information. Certain predefined status entries may be requested, including planned, in-progress, and in-production, as described above with reference to the best practice assets section of practice profile template 30. In particular embodiments, best practice business drivers section 38 may include one or more fields for entry of information relating to one or more of the following:

(a) Business justification, including the specific reason the best practice candidate is funded and the criteria used by the decision makers to seek qualification of this process as a best practice.

(b) Best practice requirements, including what business requirements will be met from implementing the best practice candidate.

(c) Best practice metrics, including what metrics are in place for measuring the performance and/or compliance of this best practice candidate.

(d) Support for the enterprise strategy, including whether and to what extent the best practice candidate aligns to the business model of the enterprise. This information may also reflect work with a marketing and portfolio management unit internal or external to the enterprise to project future business opportunities for the best practice candidate.

(e) Client relationship life cycles, including where the best practice candidate fits into the client relationship life cycle of the enterprise. In particular embodiments, the client relationship life cycle includes a growth phase, a planning phase, a delivery phase, or any other suitable phases according to particular needs. The growth phase may include a needs awareness phase, a solution exploration phase, a solution selection and contracting phase, or any other suitable phase according to particular needs. The planning phase may include a start-up/transition phase or any other suitable phase according to particular needs. The delivery phase may include a delivery results phase, a disengage phase, or any other suitable phase according to particular needs.

(f) Desired state, including a projected or desired business environment after the best practice candidate is introduced.

(g) Planned or expected improvements for the best practice candidate, including an identification of what plans are in place for future releases of the best practice candidate for a predetermined time into the future.

As illustrated in FIG. 3E, best practice business capabilities section 40 may provide the overall capacity for support organizations internal to or external to the enterprise to provide the best practice candidate in a client environment. In particular embodiments, best practice capabilities section 40 may include one or more fields for entry of information relating to one or more of the following:

(a) User community, including whether a community of practice exists to collect or disperse content or intellectual capacity. If so, the community of practice may be described in this section. A community of practice for the best practice candidate may include the people actually using the best practice in one or more engagements with clients.

(b) Number of users/practitioners, including an identification of how many qualified users exist. This figure may be based on the targeted community of users (e.g., as a percentage of the targeted community of users).

(c) Deployment capacity, including an identification of the number of people qualified to consult or assist in deploying the best practice.

(d) Design team, including an identification of the number of people involved in the core team development and maintenance activities.

(e) Established funding, including a list of any budget monies available for the development and maintenance of the best practice candidate.

As illustrated in FIG. 3F, best practice profile definitions section 42 may provide definitions for one or more terms or phrases used in practice profile template 30. In particular embodiments, best practice profile definitions section 42 may include definitions for best practice type, targeted customer base, status, or any other suitable terms or phrases according to particular needs.

Returning to the example add best practice process illustrated in FIG. 2, at step 112, a maturity assessment process may be performed to determine whether the best practice candidate qualifies as a best practice and, if so, determining which maturity assessment level to assign to the best practice candidate. In particular embodiments, the individuals responsible for step 112 include the owner of the best practice candidate and the sponsor of the best practice candidate. In particular embodiments, add best practice module 24 or another suitable component of system 10 may automatically or in combination with one or more suitable individuals initiate performance of the maturity assessment process. For example, add best practice module 24 may automatically or in combination with one or more suitable individuals or components of system 10 invoke maturity assessment module 26, illustrated in FIG. 1 for example.

Returning to the example embodiment of system 10 illustrated in FIG. 1, maturity assessment module 26 generally enables a determination of whether a best practice candidate qualifies as a best practice and, if so, what maturity level should be assigned to the best practice. For example, maturity assessment module may perform a maturity assessment process.

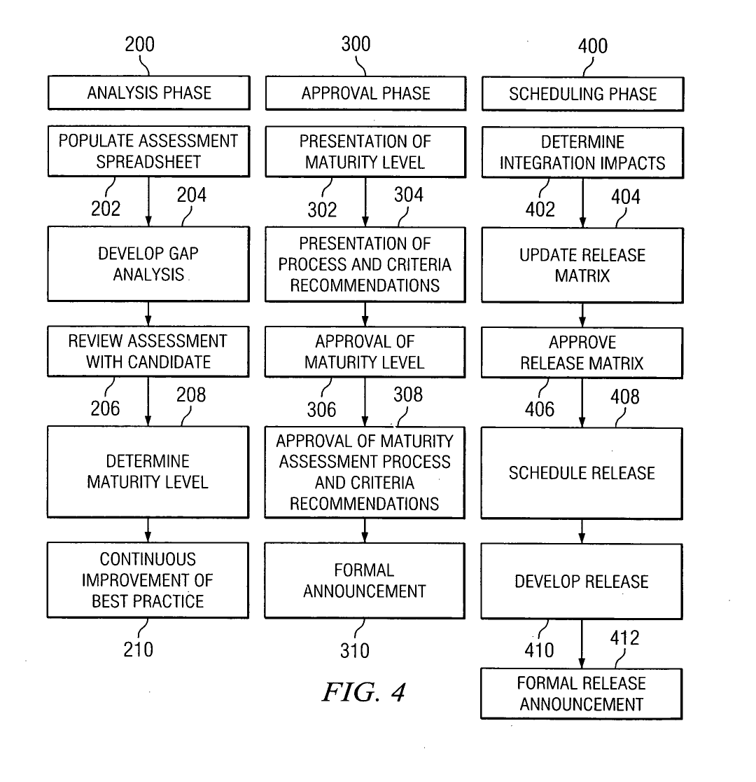

FIG. 4 illustrates an example maturity assessment process for determining whether a practice qualifies as a best practice of an enterprise and, if so, what best practice maturity level should be assigned to the practice. As an example, the maturity assessment process may be performed for a best practice candidate to determine whether the best practice candidate qualifies as a best practice and if so, what maturity level should be assigned to the best practice candidate. As another example, the maturity assessment process may be performed for an existing best practice, as part of a periodic or random review of the best practice for example, to determine whether the maturity level assigned to the best practice should be changed. In particular embodiments, the maturity assessment process, enabled by maturity assessment module 26 for example, includes an analysis phase 200, an approval phase 300, and a scheduling phase 400. Although these three phases are described, the present invention contemplates the maturity assessment process including any suitable phases according to particular needs.

In general, analysis phase 200 includes determining whether a particular practice qualifies as a best practice of the enterprise and, if so, determining what best practice maturity level should be assigned to the particular practice. Although a particular method for determining whether a particular practice qualifies as a best practice and, if so, what maturity level should be assigned to the particular practice is described below, the present invention contemplates any suitable method for determining whether a particular practice qualifies as a best practice and if so, what maturity level should be assigned to the particular practice.

In particular embodiments, steps 202 through 210 of the maturity assessment process described below may be referred to as analysis phase 200. At step 202, the maturity assessment criteria of one or more relevant maturity assessment categories may be reviewed and recorded for the best practice candidate. In particular embodiments, a maturity assessment spreadsheet template 50 (as shown in FIG. 1, for example) may be populated with scores or other data reflecting the performance of the best practice candidate with respect to the maturity assessment criteria. In particular embodiments, the inputs to step 202 include a practice profile for a best practice candidate and a maturity assessment spreadsheet template 50. In particular embodiments, one or more suitable individuals review the practice profile for best practice candidate to determine what score to determine a score for each of the maturity assessment criteria for the best practice candidate. In other embodiments, maturity assessment module 26 automatically reviews the practice profile for the best practice candidate and determines a score for each of the maturity assessment criteria for the best practice candidate. For example, the content of the practice profile for the best practice may be compared to the maturity assessment criteria and scored accordingly. Maturity assessment spreadsheet template 50 may be stored in database 20 and accessed in response to an invocation of maturity assessment module 26 or another suitable component of system 10. In particular embodiments, the outputs of step 202 include a populated assessment spreadsheet for the best practice candidate. In particular embodiments, the individuals responsible for step 202 include the sponsor of the best practice candidate.

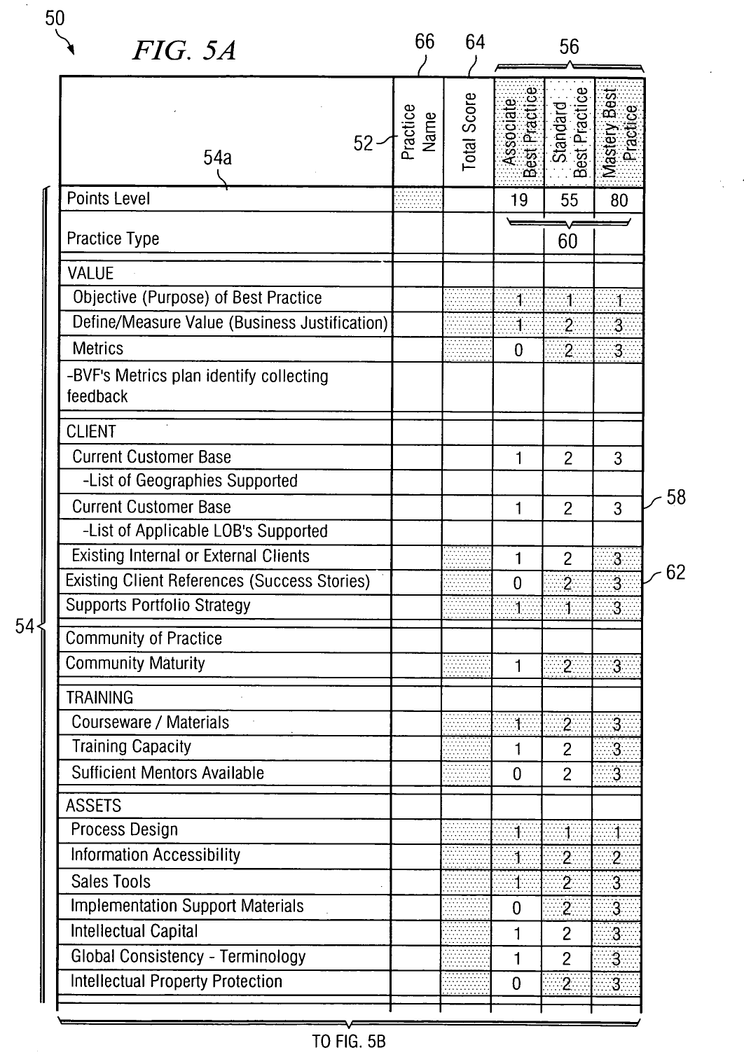

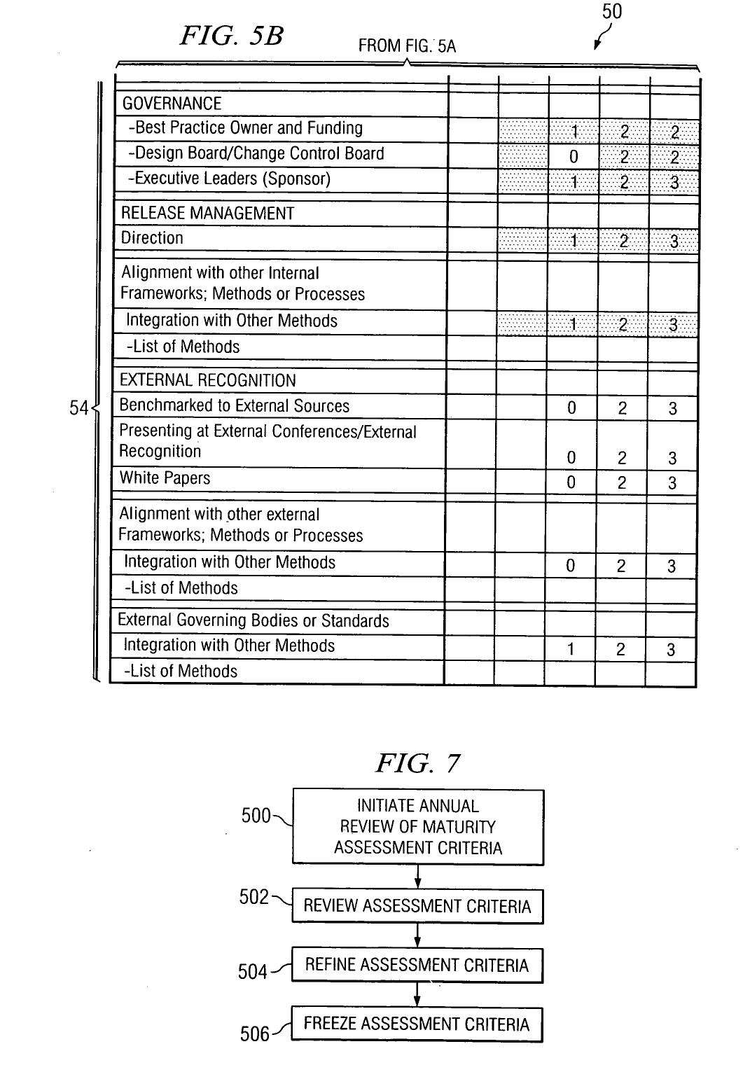

FIGS. 5A-5B illustrate an example maturity assessment spreadsheet template 50, which may be populated and used for rating the performance of a particular practice. For example, maturity assessment spreadsheet template 50 may be populated with data for a particular best practice candidate. As another example, maturity assessment spreadsheet template 50 may be populated with data for an existing best practice. Maturity assessment spreadsheet template 50 may include one or more fields 52 for entering the name of the practice whose data is to be populated in maturity assessment spreadsheet template 50.

Maturity assessment spreadsheet template 50 may include one or more rows 54, each row corresponding to one or more maturity assessment criteria or a category for one or more maturity assessment criteria. In particular embodiments, the maturity assessment criteria included in maturity assessment spreadsheet template 50 correspond to the maturity assessment criteria discussed above. Maturity assessment spreadsheet template 50 may include one or more columns 56, each corresponding to a best practice maturity level (e.g., associate best practice, standard best practice, and mastery best practice). In particular embodiments, each maturity assessment criterion includes, for each maturity level, a predefined score for determining whether a particular practice satisfies the maturity assessment criterion for the maturity level. The intersection of a row 54 corresponding to a maturity assessment criteria and a column 56 corresponding to a maturity level may include the predefined score. In particular embodiments, the score indicates the minimum score required for qualifying for the maturity level in the column 56 for the respective maturity assessment criteria in the row 54. For example, the intersection of the row 54 for the current customer base maturity assessment criteria and the column 56 for the mastery best practice maturity level includes a predefined score of three (e.g., cell 58). In particular embodiments, the predefined score of three indicates that the minimum score for qualifying as mastery best practice for the current customer base maturity assessment criteria is three. In other embodiments, the predefined scores indicate a maximum score for satisfying the maturity assessment criteria with respect to the corresponding maturity level.

The intersection of a row 54a corresponding to “points level” and a column 56 corresponding to a maturity level may include a predefined total score 60 for qualifying as the corresponding maturity level. For example, the predefined total score 60 for the associate best practice maturity level in the illustrated embodiment is nineteen, which may represent the sum of all predefined scores for each maturity assessment criteria for the maturity level. In particular embodiments, predefined total score 60 represents the minimum score required to qualify as the corresponding maturity level. In other embodiments, predefined total score 60 represents the maximum score required to qualify as the corresponding maturity level. In particular embodiments, for each of the best practice maturity levels, a range of predefined total scores for qualifying for the best practice maturity level is defined, the range of scores including a minimum predefined score for satisfying the maturity assessment criteria for the corresponding maturity level and a maximum predefined score for satisfying the maturity assessment criteria for the corresponding maturity level.

In particular embodiments, certain of the individual maturity assessment criteria may be required to be met to qualify for a particular maturity level, regardless of the total points scored. For example, a practice may be required to meet the existing internal or external clients maturity assessment criterion (e.g., by scoring a three for this criterion) to qualify as a mastery best practice. In this embodiment, one or more cells in maturity assessment spreadsheet template 50 may be highlighted, shaded, or otherwise distinguished to indicate that to qualify for the maturity level corresponding to the cell, the practice may be required to satisfy the maturity assessment criterion corresponding to the cell by meeting the predefined score in the cell (e.g., as seen in cell 62). Maturity assessment spreadsheet template 50 may include a column 64 for recording the scores of a particular practice being assessed with respect to each maturity assessment criterion. Maturity assessment spreadsheet template 50 may also include a column 50, which may be used to enter data associated with a particular practice that is relevant for a maturity assessment criterion.

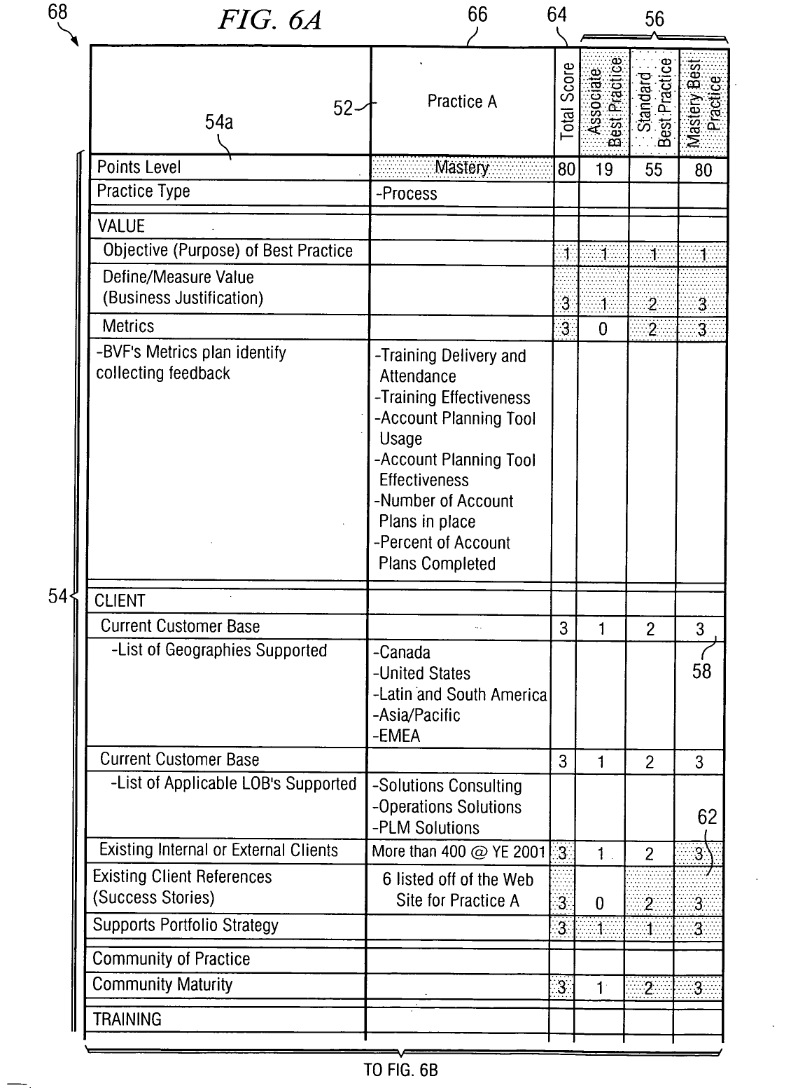

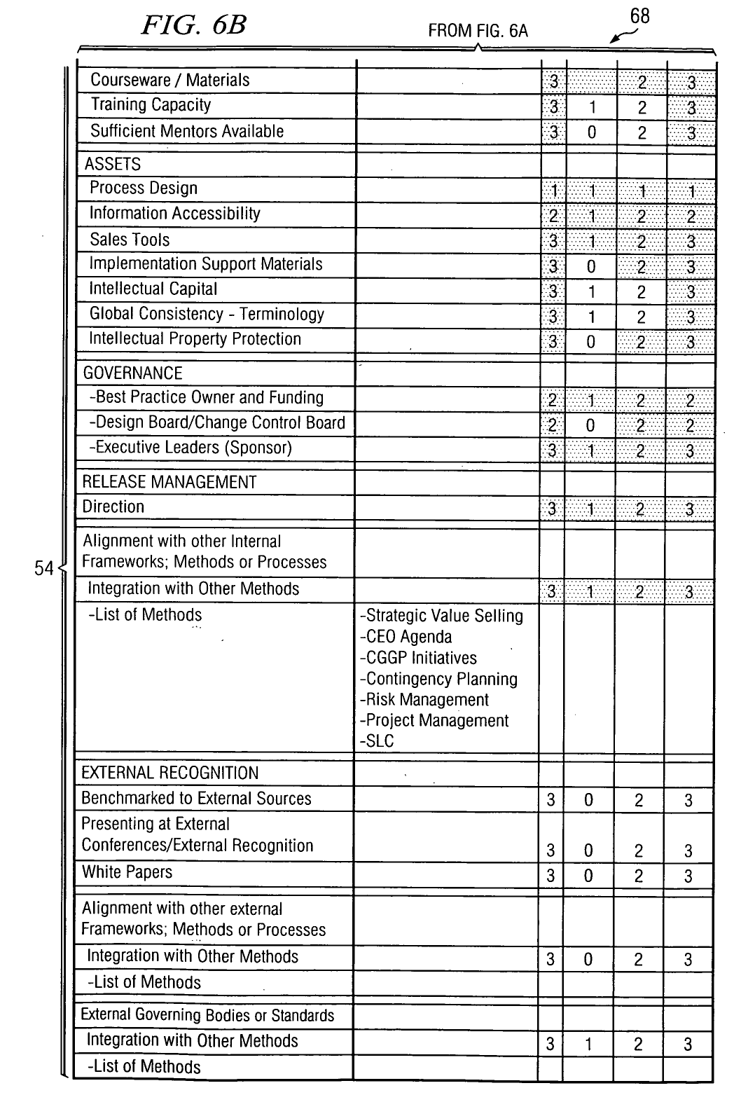

FIGS. 6A-6B illustrate an example maturity assessment spreadsheet 68 populated with scores for a particular practice. For example, maturity assessment spreadsheet 68 may be created by populating data for a particular practice (e.g., Practice A) in maturity assessment spreadsheet template 50. In particular embodiments, Practice A is a best practice candidate. In other embodiments, Practice A is an existing best practice, which is undergoing a periodic or random review of the best practice for example, to determine whether the maturity level assigned to the best practice should be changed. The practice profile for a particular practice (e.g., Practice A) and any other suitable information may be reviewed, and a score for one or more of the maturity assessment criteria may be determined based on the review. The determined score may be recorded in column 48 in a row corresponding to the relevant maturity assessment criteria. In one embodiment, maturity assessment spreadsheet 68 may be stored in database 20.

Returning to the example maturity assessment process illustrated in FIG. 4, at step 204, a gap analysis may be developed for the best practice candidate. In particular embodiments, maturity assessment module 26 facilitates development of a gap analysis for the best practice candidate. For example, the gap analysis may be used to determine one or more maturity assessment categories or one or more maturity assessment criteria within one or more maturity assessment categories on which the best practice candidate needs improvement. In particular embodiments, maturity assessment module 26 receives a populated maturity assessment spreadsheet 68 for the best practice candidate. In particular embodiments, the sponsor of the best practice candidate or another suitable individual or machine identifies one or more gaps associated with the minimum requirements for reaching a next higher maturity level. In other embodiments, gaps may be automatically identified by maturity assessment module 26 or another suitable component of system 10. In particular embodiments, maturity assessment module facilitates generation of an updated maturity assessment spreadsheet 68 for the best practice candidate. In particular embodiments, the individuals responsible for step 204 include the sponsor of the best practice candidate.

At step 206, maturity assessment module 26 or another suitable component of system 10 may automatically or in combination with one or more suitable individuals facilitate a review of maturity assessment spreadsheet 68 with the owner or another individual or group of individuals associated with the best practice candidate. In particular embodiments, maturity assessment module 26 receives the updated maturity assessment spreadsheet 68 and the practice profile for the best practice candidate. The review of maturity assessment spreadsheet 68 may include clarifying questions associated with the maturity assessment process and reviewing preliminary results of the maturity assessment process (e.g., as reflected in maturity assessment spreadsheet 68). The review of maturity assessment spreadsheet 68 may also include making any appropriate adjustments to the maturity assessment process or the best practice candidate. Maturity assessment module 26 may facilitate generation of an updated practice profile and an updated maturity assessment spreadsheet 68 for the best practice candidate, and one or more maturity assessment process and criteria recommendations. In particular embodiments, the individuals responsible for step 206 include the owner and the sponsor of the best practice candidate.

At step 208, the maturity level assigned to the best practice candidate may be determined. For example, maturity assessment module 26 or another suitable component of system 10 may automatically or in combination with one or more suitable individuals facilitate assignment of a maturity level to the best practice candidate. For example, the best practice candidate may be rejected as a best practice of any maturity level. As another example, the best practice candidate may be determined to be an associate best practice, a standard best practice, a mastery best practice, or any other suitable maturity level. In particular embodiments, maturity assessment module 26 receives the updated practice profile and the updated maturity assessment spreadsheet 68 for the best practice candidate. In particular embodiments, a maturity level is determined for the best practice candidate based upon one or more minimum requirements for qualifying for particular best practice maturity levels and one or more required maturity assessment criteria. For example, the scores reflected in the updated maturity assessment spreadsheet 68 for the best practice candidate may be compared to one or more the threshold scores for each maturity level to determine the applicable maturity level. As a more concrete example, the scores recorded in column 48 of maturity assessment spreadsheet 68 may be summed to calculate a total score, which may be recorded in column 48 in the cell corresponding to the “points level” row 54. This total score may be compared with the total predefined scores 60 for each of the maturity levels to determine which maturity level should be assigned to the practice (e.g., Practice A), if any. In particular embodiments, the individuals responsible for step 208 include the owner and the sponsor of the best practice candidate.

In particular embodiments, certain of the maturity assessment criteria are required to qualify for a certain maturity levels (e.g., as indicated by shaded cells such as cell 62). In particular embodiments, to qualify for a particular maturity level, a practice may be required to satisfy substantially all or all required maturity assessment criteria (i.e., by meeting the predefined score for each of the required maturity assessment criteria) in addition to meeting the total predefined score for the particular maturity level. Maturity assessment module 26 may facilitate generation of an updated maturity assessment spreadsheet 68 for the best practice candidate, indicating the maturity level assigned to the best practice candidate.

At step 210, the best practice candidate may be improved. For example, maturity assessment module 26 or another suitable component of system 10 may automatically or in combination with one or more suitable individuals facilitate improvement of the best practice candidate. For example, it may be desirable to continuously improve the best practice candidate. Maturity assessment module 26 may receive best practice integration program collateral and collateral associated with the best practice candidate (best practice candidate collateral). In particular embodiments, the owner of the best practice candidate develops a release plan for the best practice candidate, which may include one or more items for achieving a higher maturity level for the best practice candidate. In particular embodiments, maturity assessment module 26 facilitates generation of updated best practice candidate collateral. In particular embodiments, the individuals responsible for step 210 include the owner and the sponsor of the best practice candidate.

In general, approval phase 300 includes presenting the maturity level assigned to the best practice candidate to one or more suitable individuals. In particular embodiments, steps 302 through 310 of the maturity assessment process described below may be referred to as approval phase 300. At step 302, the maturity level assigned to the best practice candidate may be presented to one or more suitable individuals. In particular embodiments, the inputs to step 302 include an overview of the best practice candidate and the updated assessment spreadsheet for the best practice candidate. For example, maturity assessment module 26 or another suitable component of system 10 may receive an overview of the best practice candidate and the updated assessment spreadsheet for the best practice candidate. In particular embodiments, the owner of the best practice candidate attends a design board meeting and presents an overview of the best practice candidate. A summary of the best practice assessment results and the recommended maturity level may also be presented. In particular embodiments, the outputs from step 302 include design board meeting minutes. In particular embodiments, maturity assessment module 26 may facilitate generation of the design board meeting minutes. In particular embodiments, the individuals responsible for step 302 include the owner and the sponsor of the best practice candidate, the members of the design board, a best practice integration component owner, and the master scheduler.

At step 304, the maturity assessment categories, maturity assessment criteria for each maturity assessment category, the process for determining the maturity level to assign to the best practice candidate, or any other suitable information may be presented to one or more suitable individuals. For example, maturity assessment module 26 or another suitable component of system 10 may automatically or in combination with one or more suitable individuals facilitate presentation of the maturity assessment categories, maturity assessment criteria for each maturity assessment category, the process for determining the maturity level to assign to the best practice candidate, or any other suitable information to one or more suitable individuals. In particular embodiments, maturity assessment module 26 or another suitable component of system 10 may receive the maturity assessment categories, the maturity assessment criteria for each maturity assessment category, the process for determining the maturity level to assign to the best practice candidate, and one or more criteria recommendations and communicates or otherwise presents these materials to the design board or other suitable individuals.

In particular embodiments, the sponsor of the best practice candidate process presents one or more recommendations to the design board or other suitable individuals regarding how to improve the best practice maturity assessment process, best practice maturity assessment criteria, or other suitable information or steps. In particular embodiments, maturity assessment module 26 facilitates generation of design board meeting minutes, an updated best practice maturity assessment process, and one or more criteria recommendations. In particular embodiments, the individuals responsible for step 304 include members of the design board, the sponsor of the best practice candidate, and the best practice integration component owner.

At step 306, a determination is made regarding whether to approve the maturity level assigned to the best practice candidate. In particular embodiments, the inputs to step 306 include the updated assessment spreadsheet for the best practice candidate. For example, maturity assessment module 26 or another suitable component of system 10 may automatically or in combination with one or more suitable individuals facilitate a determination of whether to approve the maturity level assigned to the best practice candidate. In particular embodiments, the inputs to step 314 include the updated assessment spreadsheet for the best practice candidate. In particular embodiments, an appropriate maturity level is assigned to the best practice candidate based upon the minimum requirements for each maturity level as represented by the maturity assessment criteria and the maturity assessment results for the best practice candidate. For example, the maturity level determined at step 306 may match the maturity level determined at step 208. As another example, the maturity level determined at step 306 may be different that the maturity level determined at step 208 and may reflect an updated assignment of a maturity level that overrides the maturity level determined at step 208.

In particular embodiments, the outputs of step 306 include an agreement to schedule the assets of the best practice candidate into the best practice integration program collateral. For example, maturity assessment module 26 or another suitable component of system 10 may facilitate generation of an agreement to schedule the assets of the best practice candidate into the best practice integration program collateral. In particular embodiments, the individuals responsible for step 306 include members of the design board, the owner and the sponsor of the best practice candidate, the best practice integration component owner, and the master scheduler.

At step 308, a determination is made regarding whether to approve the maturity assessment categories, maturity assessment criteria for each maturity assessment category, and the process for determining the maturity level to assign to the best practice candidate. For example, maturity assessment module 26 or another suitable component of system 10 may automatically or in combination with one or more suitable individuals facilitate a determination of whether to approve the maturity assessment categories, maturity assessment criteria for each maturity assessment category, and the process for determining the maturity level to assign to the best practice candidate. In particular embodiments, the inputs to step 308 include updated maturity assessment criteria recommendations. In particular embodiments, members of the design board provide input regarding the proposed maturity assessment criteria recommendations. In particular embodiments, the outputs of step 308 include approved maturity assessment process and criteria recommendations. In particular embodiments, the individuals responsible for step 308 include members of the design board, the sponsor of the best practice candidate, and the best practice integration component owner.

At step 310, a formal announcement may be made regarding the maturity level assigned to the process. For example, maturity assessment module 26 or another suitable component of system 10 may automatically or in combination with one or more suitable individuals facilitate the making of a formal announcement regarding the maturity level assigned to the process. In particular embodiments, the inputs to step 310 include the approved maturity level for the best practice candidate (i.e., which is no longer a candidate, but an approved best practice having the level assigned to it) and an announcement template. In particular embodiments, an announcement is created for the addition of a new best practice (i.e., the best practice candidate) or for an existing best practice that qualified for an upward progression in the maturity level assigned to it (e.g., a best practice that was previously assigned a maturity level of standard best practice is now assigned a maturity level of mastery best practice).

The announcement may include posting the maturity level assigned to best on a web site (either internal or external) associated with the enterprise; however, the present invention contemplates making the announcement in any suitable manner according to particular needs. Furthermore, the present invention contemplates the announcement including a rejection of the best practice candidate indicating that the best practice candidate is not suitable for any of the maturity levels associated with being a best practice, if appropriate. In particular embodiments, the individuals responsible for step 310 include the owner of the best practice candidate and a best practice integration communications specialist.

In general, scheduling phase 400 includes determining one or more integration impacts, which may reflect the impact of integrating the new best practice with existing best practices. In particular embodiments, steps 402 through 412 of the maturity assessment process described below may be referred to as scheduling phase 400. At step 402, one or more integration impacts may be determined, the integration impacts reflecting the impact of integrating the new best practice with existing best practices. In particular embodiments, the inputs to step 402 include the updated practice profile for the new best practice, an updated assessment spreadsheet for the new best practice, the best practice integration program collateral, and the collateral for the new best practice (i.e., the best practice candidate collateral). For example, maturity assessment module 26 may receive or access the updated practice profile for the new best practice, an updated assessment spreadsheet for the new best practice, the best practice integration program collateral, and the collateral for the new best practice (i.e., the best practice candidate collateral). In particular embodiments, maturity assessment module may automatically or in combination with one or more suitable individuals (e.g., a best practice integration web owner and the master scheduler) may work with the owner of the new best practice to determine various impacts on the best practice integration program collateral and the collateral for the new best practice. In particular embodiments, the outputs of step 402 include an impact document detailing the one or more determined integration impacts. In particular embodiments, the individuals responsible for step 402 include the master scheduler, the owner of the new best practice, and the best practice integration web component owner.

At step 404, a release matrix may be updated to include the new best practice. For example, maturity assessment module 26 or another suitable component of system 10 may automatically or in combination with one or more suitable individuals facilitate the updating of a release matrix to include the new best practice. In particular embodiments, the inputs to step 404 include the impact document, a best practice integration program release matrix, and approved maturity assessment process and criteria recommendations. In particular embodiments, the maturity assessment automatically or in combination with one or more suitable individuals populates the best practice integration program release matrix with the items identified in the impact document in order to integrate the assets of the new best practice into the best practice integration program collateral. In particular embodiments, the outputs of step 404 include an updated best practice integration program release matrix. In particular embodiments, the individuals responsible for step 404 include the master scheduler.

At step 406, an approval process may be applied to the updated release matrix. For example, maturity assessment module 26 or another suitable component of system 10 may automatically or in combination with one or more suitable individuals facilitate application of an approval process to the updated release matrix. In particular embodiments, the inputs to step 406 include the updated best practice integration program release matrix. In particular embodiments, maturity assessment module 26 automatically or in combination with one or more suitable individuals (e.g., the design board) applies an approval process to the updated best practice integration program release matrix. In particular embodiments, the outputs of step 406 include an approved best practice integration program release matrix. In particular embodiments, the individuals responsible for step 406 include the master release scheduler, the best practice integration component owner, and the design board.

At step 408, if the updated release matrix is approved, the release may be scheduled. For example, maturity assessment module 26 or another suitable component of system 10 may automatically or in combination with one or more suitable individuals facilitate the scheduling of an approved updated release matrix. In particular embodiments, the inputs to step 408 include the updated best practice integration program release matrix and the best practice integration program release schedule. In particular embodiments, maturity assessment module 26 automatically or in combination with one or more suitable individuals updates the best practice integration program release schedule to include the deliverables required to integrate the assets of the new best practice into the best practice integration program. In particular embodiments, the outputs of step 408 include an updated best practice integration program release schedule. In particular embodiments, the individuals responsible for step 408 include a release manager.

At step 410, the release may be developed. For example, maturity assessment module 26 or another suitable component of system 10 may automatically or in combination with one or more suitable individuals facilitate development of the release. In particular embodiments, the inputs to step 410 include the best practice integration program release schedule. In particular embodiments, the release development activity is focused on constructing the designs for each of the impacted components. In particular embodiments, the outputs of step 410 include one or more release deliverables. In particular embodiments, the individuals responsible for step 410 include the release manager.

At step 412, a formal release announcement may be made. For example, maturity assessment module 26 or another suitable component of system 10 may automatically or in combination with one or more suitable individuals facilitate the making of a formal release announcement. In particular embodiments, the inputs to step 412 include updated best practice integration program collateral, updated candidate best practice program collateral, and a communication plan. In particular embodiments, maturity assessment module 26 automatically or in combination with one or more suitable individuals or components makes an announcement regarding enhancements to the best practice integration program collateral. In particular embodiments, the outputs of step 412 include an appropriate communication being delivered to one or more appropriate target audiences. In particular embodiments, the individuals responsible for step 412 include the release manager and a best practice integration communications specialist.

Returning to the example embodiment of system 10 illustrated in FIG. 1, best practices tool 18 may, in particular embodiments, include review maturity assessment criteria module 28. In general, review maturity assessment criteria module 28 may be used to perform a review process for reviewing and updating the maturity assessment criteria used to determine whether a practice qualifies as a best practice and if so, what maturity level should be assigned to the practice. The review may be performed at a regular interval (e.g., annually), at random, or as otherwise directed according to particular needs or desires.

FIG. 7 illustrates an example review maturity assessment criteria process. At step 500, a review of maturity assessment criteria for a best practice is initiated. For example, review maturity assessment criteria module 28 or another suitable component of system 10 may automatically or in combination with one or more suitable individuals facilitate initiation of a review of maturity assessment criteria.

At step 502, the maturity assessment criteria are reviewed and analyzed with respect to the best practice. For example, review maturity assessment criteria module 28 or another suitable component of system 10 may automatically or in combination with one or more suitable individuals facilitate a review and analysis of the maturity assessment criteria with respect to a best practice. In particular embodiments, the inputs to step 502 include one or more maturity assessment criteria. Review maturity assessment criteria module 28 may automatically or in combination with one or more suitable individuals (e.g., design board members, component owners, etc.) or other components of system 10 review the maturity assessment criteria to ensure that they address the enterprise's current understanding of what is required or desired to qualify as a best practice. In particular embodiments, the outputs of step 502 include updated approved maturity assessment criteria recommendations. In particular embodiments, the individuals responsible for step 502 include design board members and one or more component owners.

At step 504, the maturity assessment criteria may be refined. For example, review maturity assessment criteria module 28 or another suitable component of system 10 may automatically or in combination with one or more suitable individuals facilitate a refinement of the maturity assessment criteria. In particular embodiments, the inputs to step 504 include maturity assessment criteria, one or more updated, approved maturity assessment criteria recommendations, or any other suitable inputs. In particular embodiments, review maturity assessment criteria module 28 automatically or in combination with one or more suitable individuals (e.g., component owners) or components of system 10 refines the maturity assessment criteria to help ensure that they incorporate the updated, approved maturity assessment criteria recommendations. In particular embodiments, the outputs of step 504 include one or more updated maturity assessment criteria. In particular embodiments, the individuals responsible for step 504 include one or more component owners.

At step 506, the maturity assessment criteria may be frozen. For example, review maturity assessment criteria module 28 or another suitable component of system 10 may automatically or in combination with one or more suitable individuals facilitate a freeze of the maturity assessment criteria. In particular embodiments, the inputs to step 506 include one or more updated maturity assessment criteria. In particular embodiments, review maturity assessment criteria module 28 automatically or in combination with one or more suitable individuals (e.g., design board members, component owners, etc.) or components of system 10 freeze the maturity assessment criteria for the reviews of either existing best practices or best practice candidates (e.g., annually). In particular embodiments, the outputs of step 506 include one or more frozen maturity assessment criteria. In particular embodiments, the individuals responsible for step 506 include one or more design board members and one or more component owners.

Although particular processes have been described with reference to FIGS. 2, 4, and 7, the present invention contemplates any suitable processes for performing the operations of system 10 in accordance with the present invention. Thus, certain of the steps described with reference to FIGS. 2, 4, and 7 may take place simultaneously and/or in different orders than as shown. Moreover, system may use processes with additional steps, fewer steps, and/or different steps, so long as the processes remain appropriate.

Although the present invention has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

1. A process for identifying and monitoring one or more best practices of an enterprise, comprising:
defining a set of criteria for determining whether each of a plurality of practices of the enterprise qualify as a best practice of the enterprise;
receiving a practice profile of a particular practice of the enterprise, the practice profile comprising information associated with the particular practice and relating to one or more of the criteria; and
performing a maturity assessment process to determine, based on a comparison between the practice profile for the particular practice and the set of criteria, whether the particular practice qualifies as a best practice of the enterprise and, if the particular practice so qualifies, assigning a best practice maturity level to the particular practice, the best practice maturity level defining to what degree the particular practice qualifies as a best practice of the enterprise.

2. The process of claim 1, wherein the practice profile comprises a template populated with information specific to the particular practice, the template comprising a plurality of fields for entering information specific to the particular practice and relating to the criteria.

3. The process of claim 1, wherein determining whether the particular practice qualifies as a best practice of the enterprise comprises determining if the best practice qualifies for a best practice maturity level.

4. The process of claim 1, wherein the maturity assessment process comprises, for one or more criteria in the set of criteria, assigning a score to the particular practice based at least on the information in the practice profile of the particular practice relating to the one or more criteria, the score indicating to what degree the particular practice meets the criteria.

5. The process of the claim 4, wherein:
one or more criteria in the set of criteria comprise, for each best practice maturity level, a predefined score for determining whether the particular practice satisfies the criterion for the best practice maturity level;
each best practice maturity level is associated with a predefined total score reflecting a sum of the predefined scores for each criterion in the set of criteria for the best practice maturity level; and
the maturity assessment process comprises:
summing the scores of the particular practice for each criterion in the set of criteria to determine a total score; and
determining whether to assign the particular practice a particular best practice maturity level by comparing the total score for the particular practice to the predefined total score for the particular best practice maturity level.

6. The process of the claim 5, comprising, for each best practice maturity level:
defining for each best practice maturity level a minimum predefined total score required for the particular practice to be assigned to the particular best practice maturity level and a maximum predefined total score required for the particular practice to be assigned to the particular best practice maturity level;
determining whether to assign the particular practice to a particular best practice maturity level by determining whether the total score for the particular practice falls on or between the maximum and minimum predefined total scores for the particular best practice maturity level.

7. The process of the claim 4, wherein:
one or more criteria in the set of criteria comprise, for each best practice maturity level, a predefined score for determining whether the particular practice satisfies the criterion for the best practice maturity level; and
the maturity assessment process comprises determining whether the particular practice satisfies one or more criteria for a particular best practice maturity level by comparing the score assigned to the particular practice for a criterion to the predefined score for satisfying the criterion.

8. The process of claim 1, wherein each best practice maturity level comprises one or more required criteria in the set of criteria, determining the maturity level to assign to the particular practice comprising determining whether the particular practice satisfies all of the one or more required criteria for each maturity level.

9. The process of claim 1, wherein performing the maturity assessment process comprises one or more of the following:
an analysis phase for determining the best practice maturity level to assign to the particular practice;
an approval phase for approving the best practice maturity level assigned to the particular practice in the analysis phase; and
a scheduling phase for integrating the particular practice with other best practices of the enterprise.

10. The process of claim 1, wherein the maturity assessment process is performed automatically by a computer system comprising one or more processors and one or more memory units.

11. The process of claim 1, wherein the best practice maturity levels comprise one or more of:
an associate best practice maturity level;
a standard best practice maturity level; and
a mastery best practice maturity level.

12. The process of claim 1, wherein:
the particular practice comprises an existing best practice of the enterprise; and
the maturity assessment process comprises a review of the existing best practice to determine if the existing best practice still qualifies as a best practice of the enterprise and, if the existing best practice so qualifies:
determining, based on the comparison between the practice profile for the existing best practice and the set of criteria, whether a best practice maturity level currently assigned to the best practice should be changed; and
assigning a new best practice maturity level to the existing best practice if it is determined that the best practice maturity level currently assigned to the best practice should be changed.

13. The process of claim 12, wherein the review of the existing best practice is performed annually.

14. The process of claim 1, wherein:
the particular practice comprises a best practice candidate that is not an existing best practice of the enterprise; and
the maturity assessment process comprises determining, based on the comparison between the practice profile for the best practice candidate and the set of criteria, whether the best practice candidate qualifies as a best practice of the enterprise, and if the best practice candidate so qualifies, assigning a best practice maturity level to the best practice candidate.

15. The process of claim 1, wherein the practice comprises one or more of:
a methodology of the enterprise;
a framework of the enterprise;
a method of the enterprise; and
a process of the enterprise.

16. The process of claim 1, further comprising performing a review maturity assessment criteria process, comprising:
reviewing the set of criteria to determine if the set of criteria reflect current views of the enterprise for determining best practices of the enterprise; and
if the set of criteria are determined to not reflect current views of the enterprise for determining best practices of the enterprise, refining the set of criteria to reflect current views of the enterprise for determining best practices of the enterprise.

17. A system for identifying and monitoring one or more best practices of an enterprise, comprising:
a database operable to store a set of predefined criteria for determining whether each of a plurality of practices of the enterprise qualify as a best practice of the enterprise;
a best practices tool operable to:
receive a practice profile of a particular practice of the enterprise, the practice profile comprising information associated with the particular practice and relating to one or more of the criteria; and
perform a maturity assessment process to determine, based on a comparison between the practice profile for the particular practice and the set of criteria, whether the particular practice qualifies as a best practice of the enterprise and, if the particular practice so qualifies, assign a best practice maturity level to the particular practice, the best practice maturity level defining to what degree the particular practice qualifies as a best practice of the enterprise.

18. The system of claim 17, wherein the best practices tool is further operable to, for one or more criteria in the set of criteria, assign a score to the particular practice based at least on the information in the practice profile of the particular practice relating to the one or more criteria, the score indicating to what degree the particular practice meets the criteria.

19. The system of the claim 18, wherein:
one or more criteria in the set of criteria comprise, for each best practice maturity level, a predefined score for determining whether the particular practice satisfies the criterion for the best practice maturity level;
each best practice maturity level is associated with a predefined total score reflecting a sum of the predefined scores for each criterion in the set of criteria for the best practice maturity level; and
the best practices tool is further operable to:
sum the scores of the particular practice for each criterion in the set of criteria to determine a total score; and
determine whether to assign the particular practice a particular best practice maturity level by comparing the total score for the particular practice to the predefined total score for the particular best practice maturity level.

20. The system of the claim 19, wherein:
for each best practice maturity level, a minimum predefined total score required for the particular practice to be assigned to the particular best practice maturity level and a maximum predefined total score required for the particular practice to be assigned to the particular best practice maturity level are defined;
the best practices tool is further operable to determine whether to assign the particular practice to a particular best practice maturity level by determining whether the total score for the particular practice falls on or between the maximum and minimum predefined total scores for the particular best practice maturity level.

21. The system of the claim 18, wherein:
one or more criteria in the set of criteria comprise, for each best practice maturity level, a predefined score for determining whether the particular practice satisfies the criterion for the best practice maturity level; and
the best practices tool is further operable to determine whether the particular practice satisfies one or more criteria for a particular best practice maturity level by comparing the score assigned to the particular practice for a criterion to the predefined score for satisfying the criterion.

22. The system of claim 17, wherein each best practice maturity level comprises one or more required criteria in the set of criteria, determining the maturity level to assign to the particular practice comprising determining whether the particular practice satisfies all of the one or more required criteria for each maturity level.

23. The system of claim 17, wherein performing the maturity assessment process comprises one or more of the following:
an analysis phase for determining the best practice maturity level to assign to the particular practice;
an approval phase for approving the best practice maturity level assigned to the particular practice in the analysis phase; and
a scheduling phase for integrating the particular practice with other best practices of the enterprise.

24. The system of claim 17, wherein the best practice maturity levels comprise one or more of:
an associate best practice maturity level;
a standard best practice maturity level; and
a mastery best practice maturity level.

25. The system of claim 17, wherein:
the particular practice comprises an existing best practice of the enterprise; and
the maturity assessment process comprises a review of the existing best practice to determine if the existing best practice still qualifies as a best practice of the enterprise and, if the existing best practice so qualifies:
determining, based on the comparison between the practice profile for the existing best practice and the set of criteria, whether a best practice maturity level currently assigned to the best practice should be changed; and
assigning a new best practice maturity level to the existing best practice if it is determined that the best practice maturity level currently assigned to the best practice should be changed.

26. The system of claim 17, wherein:
the particular practice comprises a best practice candidate that is not an existing best practice of the enterprise; and
the maturity assessment process comprises determining, based on the comparison between the practice profile for the best practice candidate and the set of criteria, whether the best practice candidate qualifies as a best practice of the enterprise, and if the best practice candidate so qualifies, assigning a best practice maturity level to the best practice candidate.

27. The system of claim 17, wherein the best practices tool is further operable to perform a review maturity assessment criteria process, comprising:
reviewing the set of criteria to determine if the set of criteria reflect current views of the enterprise for determining best practices of the enterprise; and
if the set of criteria are determined to not reflect current views of the enterprise for determining best practices of the enterprise, refining the set of criteria to reflect current views of the enterprise for determining best practices of the enterprise.

28. Software for identifying and monitoring one or more best practices of an enterprise, the software being embodied in computer-readable media and when executed operable to:
define a set of criteria for determining whether each of a plurality of practices of the enterprise qualify as a best practice of the enterprise;
receive a practice profile of a particular practice of the enterprise, the practice profile comprising information associated with the particular practice and relating to one or more of the criteria; and
perform a maturity assessment process to determine, based on a comparison between the practice profile for the particular practice and the set of criteria, whether the particular practice qualifies as a best practice of the enterprise and, if the particular practice so qualifies, assign a best practice maturity level to the particular practice, the best practice maturity level defining to what degree the particular practice qualifies as a best practice of the enterprise.

29. The software of claim 28, further operable to, for one or more criteria in the set of criteria, assign a score to the particular practice based at least on the information in the practice profile of the particular practice relating to the one or more criteria, the score indicating to what degree the particular practice meets the criteria.

30. The software of the claim 29, wherein:
one or more criteria in the set of criteria comprise, for each best practice maturity level, a predefined score for determining whether the particular practice satisfies the criterion for the best practice maturity level;
each best practice maturity level is associated with a predefined total score reflecting a sum of the predefined scores for each criterion in the set of criteria for the best practice maturity level; and
the software is further operable to:
sum the scores of the particular practice for each criterion in the set of criteria to determine a total score; and
determine whether to assign the particular practice a particular best practice maturity level by comparing the total score for the particular practice to the predefined total score for the particular best practice maturity level.

31. The software of the claim 30, wherein:
for each best practice maturity level, a minimum predefined total score required for the particular practice to be assigned to the particular best practice maturity level and a maximum predefined total score required for the particular practice to be assigned to the particular best practice maturity level are defined;
the software is further operable to determine whether to assign the particular practice to a particular best practice maturity level by determining whether the total score for the particular practice falls on or between the maximum and minimum predefined total scores for the particular best practice maturity level.

32. The software of the claim 29, wherein:
one or more criteria in the set of criteria comprise, for each best practice maturity level, a predefined score for determining whether the particular practice satisfies the criterion for the best practice maturity level; and
the software is further operable to determine whether the particular practice satisfies one or more criteria for a particular best practice maturity level by comparing the score assigned to the particular practice for a criterion to the predefined score for satisfying the criterion.

33. The software of claim 28, wherein each best practice maturity level comprises one or more required criteria in the set of criteria, determining the maturity level to assign to the particular practice comprising determining whether the particular practice satisfies all of the one or more required criteria for each maturity level.

34. The software of claim 28, wherein performing the maturity assessment process comprises one or more of the following:
an analysis phase for determining the best practice maturity level to assign to the particular practice;
an approval phase for approving the best practice maturity level assigned to the particular practice in the analysis phase; and
a scheduling phase for integrating the particular practice with other best practices of the enterprise.

35. The software of claim 28, wherein the best practice maturity levels comprise one or more of:
an associate best practice maturity level;
a standard best practice maturity level; and
a mastery best practice maturity level.

36. The software of claim 28, wherein:
the particular practice comprises an existing best practice of the enterprise; and
the maturity assessment process comprises a review of the existing best practice to determine if the existing best practice still qualifies as a best practice of the enterprise and, if the existing best practice so qualifies:
determining, based on the comparison between the practice profile for the existing best practice and the set of criteria, whether a best practice maturity level currently assigned to the best practice should be changed; and
assigning a new best practice maturity level to the existing best practice if it is determined that the best practice maturity level currently assigned to the best practice should be changed.

37. The software of claim 28, wherein:
the particular practice comprises a best practice candidate that is not an existing best practice of the enterprise; and
the maturity assessment process comprises determining, based on the comparison between the practice profile for the best practice candidate and the set of criteria, whether the best practice candidate qualifies as a best practice of the enterprise, and if the best practice candidate so qualifies, assigning a best practice maturity level to the best practice candidate.

38. The software of claim 28, further operable to perform a review maturity assessment criteria process, comprising:
reviewing the set of criteria to determine if the set of criteria reflect current views of the enterprise for determining best practices of the enterprise; and
if the set of criteria are determined to not reflect current views of the enterprise for determining best practices of the enterprise, refining the set of criteria to reflect current views of the enterprise for determining best practices of the enterprise.
